(19) United States
(12) Patent Application Publication
(10) Pub. No.: US 2026/0298669 A1
(43) Pub. Date: Oct. 1, 2026

(54) CASCADED SENSE COIL ARRANGEMENT FOR INDUCTIVE ANGULAR POSITION SENSING OVER MULTIPLE ANGULAR POSITION MEASUREMENT RANGES

(71) Applicant: Microchip Technology Incorporated, Chandler, AZ (US)

(72) Inventor: Ganesh Shaga, Warangal (IN)

(21) Appl. No.: 19/222,004

(22) Filed: May 29, 2025

(30) Foreign Application Priority Data
Mar. 26, 2025 (IN) 202511028435

(51) Int. Cl. G01D 5/20

(52) U.S. Cl. CPC G01D 5/2053; G01D 2205/26

(57) ABSTRACT

An apparatus comprises a support structure and planar coils comprising conductive traces on, or in, multiple layers of the support structure. The planar coils include a cascaded sense coil arrangement defining a continuous path between a first node and a second node. The cascaded sense coil arrangement comprises a sense coil including a forward coil path defining M in-phase lobes arranged about an axis and a return coil path defining M out-of-phase lobes arranged about the axis. The cascaded sense coil arrangement comprises an additional sense coil including a forward coil path defining one or more N in-phase lobes arranged about the axis and a return coil path defining one or more N out-of-phase lobes arranged about the axis. The additional sense coil is connected in series between first and second segments of the sense coil.

### PRIORITY CLAIM

This application claims the benefit of the filing date of Republic of India Provisional Patent Application No. 202511028435, filed Mar. 26, 2025, for “Sense Coil Structure for Inductive Angular position Sensing Over Multiple Distinct Measurement Ranges,” the disclosure of which is hereby incorporated herein in its entirety by this reference.

### FIELD

Examples relate, generally, to inductive angular position sensing. More specifically, some examples relate to inductive angular position sensors for measuring the position of a rotatable target, without limitation. Additionally, related apparatuses and methods are disclosed.

### BACKGROUND

If a coil of wire is placed in a changing magnetic field, a voltage will be induced at ends of coil of wire. In a predictably changing magnetic field, the induced voltage will be predictable (based on factors including the area of the coil affected by the magnetic field and the degree of change of the magnetic field). It is possible to disturb a predictably changing magnetic field and measure a resulting change in the voltage induced in the coil of wire. Further, it is possible to create a sensor that measures movement of a disturber of a predictably changing magnetic field based on a change in a voltage induced in a coil of wire.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a top-down view of an apparatus comprising an inductive angular position sensor, according to one or more examples;

FIG. 2 is a top-down view of the apparatus comprising the inductive angular position sensor of FIG. 1;

FIG. 3 is a top-down view of the apparatus of FIGS. 1 and 2 including a target operationally situated about an axis for rotation, according to one or more examples;

FIG. 4 is a top-down view of the apparatus of FIGS. 1 and 2 including alternative target operationally situated about the axis for rotation, according to one or more examples;

FIG. 5 is a top-down view of one or more oscillator coils of the planar coils of the apparatus, according to one or more examples;

FIG. 6 is another top-down view of the one or more oscillator coils of FIG. 5 shown separated into a first oscillator coil and a second oscillator coil for illustrative clarity, according to one or more examples;

FIG. 7 depicts a set of coils including a first sense coil and a second sense coil for inductive angular position sensing over a measurement range, according to one or more examples;

FIG. 8 depicts an additional set of coils including an additional first sense coil and an additional second sense coil for additional inductive angular position sensing over an additional measurement range, according to one or more examples;

FIG. 9A depicts a first cascaded sense coil arrangement including the first sense coil of FIG. 7 and additional first sense coil of FIG. 8, according to one or more examples;

FIG. 9B depicts the first cascaded sense coil arrangement of FIG. 9A indicating a continuous path between a first node and a second node, according to one or more examples;

FIG. 9C is a close-up view of a region that surrounds a coil meeting region of the first sense coil and the additional first sense coil, the coil meeting region including inter-coil connections between the first sense coil and the additional first sense coil, according to one or more examples;

FIG. 10A depicts a second cascaded sense coil arrangement including the second sense coil of FIG. 7 and additional second sense coil of FIG. 8, according to one or more examples;

FIG. 10B depicts the second cascaded sense coil arrangement of FIG. 10A indicating a continuous path between a third node and a fourth node, according to one or more examples;

FIG. 10C is a close-up view of a region that surrounds a coil meeting region of the second sense coil and the additional second sense coil, the coil meeting region including inter-coil connections between the second sense coil and the additional second sense coil, according to one or more examples;

FIG. 11 is a schematic diagram of a position sensing circuitry for the apparatus of FIGS. 1-8, 9A-9C, and 10A-10C, according to one or more examples;

FIG. 12 is a flowchart of a method of inductive angular position sensing, according to one or more examples;

FIG. 13 is a graph of demodulated sense signals exhibited according to a simulation of operation of an inductive angular position sensing apparatus one or more examples;

FIG. 14 is a graph of additional demodulated sense signals exhibited according to a simulation of operation of an inductive angular position sensing apparatus of one or more examples; and

FIG. 15 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example of this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be depicted by block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal. A person having ordinary skill in the art would appreciate that this disclosure encompasses communication of quantum information and qubits used to represent quantum information.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general‑purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Position sensors, including angular position sensors are useful. Some examples relate to a non-contacting planar inductive sensor for measuring the position of a movable target. There are many advantages to planar inductive sensing technology, such as: contactless sensing technology, easily designed on printed circuit board (PCB) with a metallic object (e.g., formed of a metal sheet) as target, suitable for harsh environments, cost effective, resistance to magnetic fields, immune to electromagnetic interference (EMI) / electromagnetic compatibility (EMC).

An inductive angular position sensor may include an oscillator, one or more excitation coils or oscillator coils, a first sense coil, a second sense coil, and an integrated circuit (e.g., including position sensing circuitry). Such an inductive angular position sensor may determine an angular position of a target relative to the one or more oscillator coils and/or the sense coils. The oscillator may be configured to generate an excitation signal. The one or more oscillator coils may be excited by the excitation signal. The oscillating signal on the one or more oscillator coils may generate a changing (alternating) magnetic field near and especially within a space encircled by the oscillator coil. The first sense coil and the second sense coil may each encircle a space in which the one or more oscillator coils are capable of generating magnetic field, e.g., a space within the space encircled by the one or more oscillator coils. The changing magnetic field generated by the one or more oscillator coils may induce a first oscillating voltage at ends of the first sense coil and a second oscillating voltage at ends of the second sense coil. The first oscillating voltage at the ends of the first sense coil may oscillate in response to the oscillation of the excitation signal and may be a first sense signal. The second oscillating voltage at the ends of the second sense signal may oscillate in response to the oscillation of the excitation signal and may be a second sense signal.

The target may be positioned relative to the one or more oscillator coils, the first sense coil, and the second sense coil. For example, the target, or a portion of the target, may be positioned above a portion of the one or more oscillator coils, the first sense coil, and the second sense coil, without limitation. The target may disrupt some of the changing magnetic field that passes through one or more loops of the first sense coil and the second sense coil.

The first sense coil and the second sense coil may be configured such that the location of the target, or the portion of the target, above one or more of the first sense coil and the second sense coil may affect the first sense signal and the second sense signal induced in the first sense coil and the second sense coil, respectively. For example, the target may disrupt magnetic coupling between the oscillator coil and the sense coils. Such disruption may affect a magnitude of the sense signals in the sense coils. For example, in response to the target, or a the portion of the target, being over a loop in the first sense coil, the amplitude of the first sense signal may be less than the amplitude of the first sense signal when the target is not over the loop in the first sense coil.

The target may be configured to rotate (e.g., around an axis, without limitation) such that a portion of the target may pass over one or more loops of one or more of the one or more oscillator coils, the first sense coil and the second sense coil. As the target rotates, each of the first sense signal of the first sense coil and the second sense signal of the second sense coil may be amplitude modulated in response to the rotation of the target and in response to the portion of the target passing over the loops.

The integrated circuit may be configured to generate an output signal responsive to the first sense signal and the second sense signal. The output signal may be a fraction of a rail voltage based on the first sense signal and the second sense signal. The output signal may be related to an angular position of the target, or the position of the portion of the target, and successive samples of the output signal may be related to a direction of movement of the target. Thus, the inductive angular position sensor may be configured to generate an output signal indicative of an angular position of a target. In some examples, the integrated circuit may be configured to generate a first output signal based on the first sense signal and a second output signal based on the second sense signal. The first output signal may be the first sense signal demodulated; the second output signal may be the second sense signal demodulated. Together, the two output signals may be related to an angular position of the target and subsequent samples of the first and second output signals may be indicative of rotation of the target. In some examples, the integrated circuit may be configured to generate a single output signal based on the first sense signal and the second sense signal. Some examples include sense coils and/or targets that cause an integrated circuit to generate a constant-slope output signal in response to rotation of the target, relative to the first sense coil and the second sense coil. The constant-slope output signal may be an output signal with a known correlation between an amplitude of the output signal and the angular position of the target.

In some examples, sense coils and/or targets may be provided with shapes that cause sense signals from the respective sense coils to exhibit desirable waveform shapes, e.g., waveform shapes that may be ideal (or close-to-ideal) waveform shapes. The shapes of targets and/or path portions of the sense coils may be related to how the sense signals generated therein are amplitude-modulated as a target disrupts magnetic field between the oscillator coil and the sense coils. As a non-limiting example, as a target rotates above sense coils and disrupts the magnetic field between the oscillator coil and the sense coils, the shape of the target and/or the sense coils may determine the shape of an amplitude-modulation envelope exhibited by the sense signals. As a non-limiting example, an amplitude-modulation envelope of sense signals of sense coils of various examples may be close to a sinusoidal shape. A sinusoidally-shaped amplitude-modulation envelope may be well-suited for translation into an angular position, e.g., through a trigonometric function, e.g., an arctangent function.

In some traditional sensor design approaches, an inductive angular position sensing apparatus provides for angular position detection over an angular position measurement range of a rotatable target. If a different angular position measurement range is needed, then a different inductive angular position sensing apparatus with a different rotatable target may be utilized. The inventor of this disclosure has appreciated the desirability to have an inductive angular position sensing apparatus to provide for angular position detection over both a first angular position measurement range of a first rotatable target and a second angular position measurement range of a second rotatable target. Such a solution would simplify production and assembly cost, as a single sensing apparatus may be used for multiple, distinct angular position measurement ranges.

Various examples of the disclosure include an apparatus. In one example, the apparatus comprises a support structure and planar coils comprising conductive traces on, or in, multiple layers of the support structure. The planar coils include a cascaded sense coil arrangement defining a continuous path between a first node and a second node. The cascaded sense coil arrangement comprises a sense coil including a forward coil path defining M in-phase lobes arranged about an axis and a return coil path defining M out-of-phase lobes arranged about the axis. The cascaded sense coil arrangement comprises an additional sense coil including a forward coil path defining one or more N in-phase lobes arranged about the axis and a return coil path defining one or more N out-of-phase lobes arranged about the axis, where M > N ≥ 1. The additional sense coil is connected in series between first and second coil segments of the sense coil.

In another example, an apparatus comprises a support structure and planar coils comprising conductive traces on, or in, multiple layers of the support structure. The planar coils include a cascaded sense coil arrangement defining a continuous path between a first node and a second node. The cascaded sense coil arrangement comprises a sense coil and an additional sense coil. The sense coil includes a forward coil path defining M in-phase lobes circumferentially arranged about an axis. The sense coil further includes a return coil path defining M out-of-phase lobes circumferentially arranged about the axis, where M is a positive even integer greater than or equal to four (4). The additional sense coil includes a forward coil path defining one (1) in-phase lobe about the axis. The additional sense coil further includes a return coil path defining one (1) out-of-phase lobe about the axis. The sense coil has first and second ends respectively connected to the first and the second nodes. Inter-coil connections are provided in a coil meeting region of the sense coil and the additional sense coil. The inter-coil connections are to connect the additional sense coil in series between first and second coil segments of the sense coil. In one or more examples, the inter-coil connections include a first inter-coil connection to connect a first end of the additional sense coil and a first connecting end of the first coil segment of the sense coil, and a second inter-coil connection to connect a second end of the additional sense coil and a second connecting end of the second coil segment of the sense coil.

In yet another example, an apparatus comprises an inductive angular position sensor to sense inductive angular position signals associated with an angular position of a first rotatable target when the first rotatable target is set about an axis, and to sense inductive angular position signals associated with an angular position of a second rotatable target when the second rotatable target is set about the axis. The inductive angular position sensor includes a support structure and planar coils comprising conductive traces on, or in, multiple layers of the support structure. The planar coils include one or more oscillator coils, a first cascaded sense coil arrangement, and a second cascaded sense coil arrangement. The first cascaded sense coil arrangement defines a first continuous path between a first node and a second node. The first cascaded sense coil arrangement includes a first sense coil defining M pole pairs about the axis and an additional first sense coil defining one or more N pole pairs about the axis. The additional first sense coil is connected in series between first and second coil segments of the first sense coil. The second cascaded sense coil arrangement defines a second continuous path between a third node and a fourth node. The second cascaded sense coil arrangement includes a second sense coil defining the M pole pairs and an additional second sense coil defining the one or more N pole pairs. The additional second sense coil is connected in series between first and second coil segments of the second sense coil, and M > N ≥ 1.

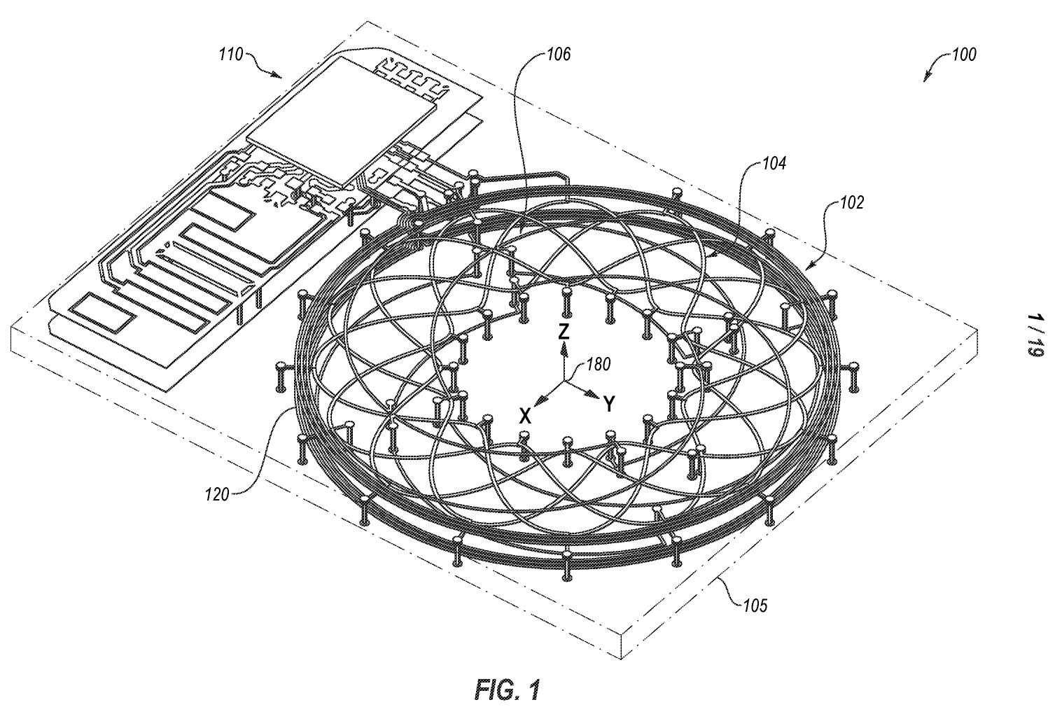

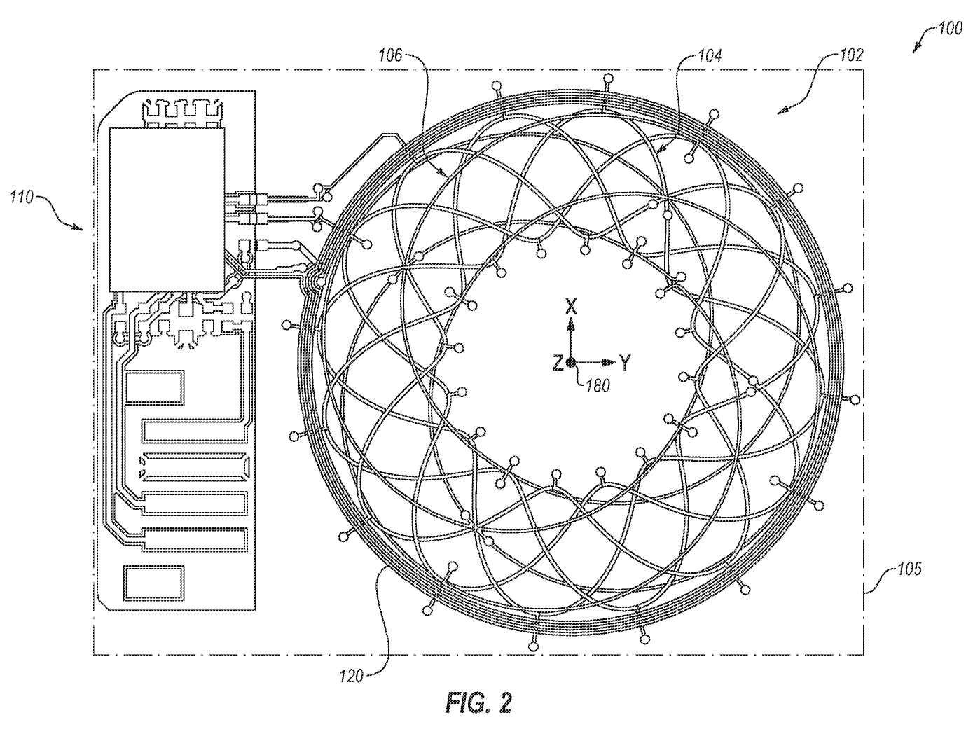

FIG. 1 is a top-down view of an apparatus 100 for inductive angular position sensing, according to one or more examples. FIG. 2 is a top-down view of apparatus 100 for inductive angular position sensing of FIG. 1.

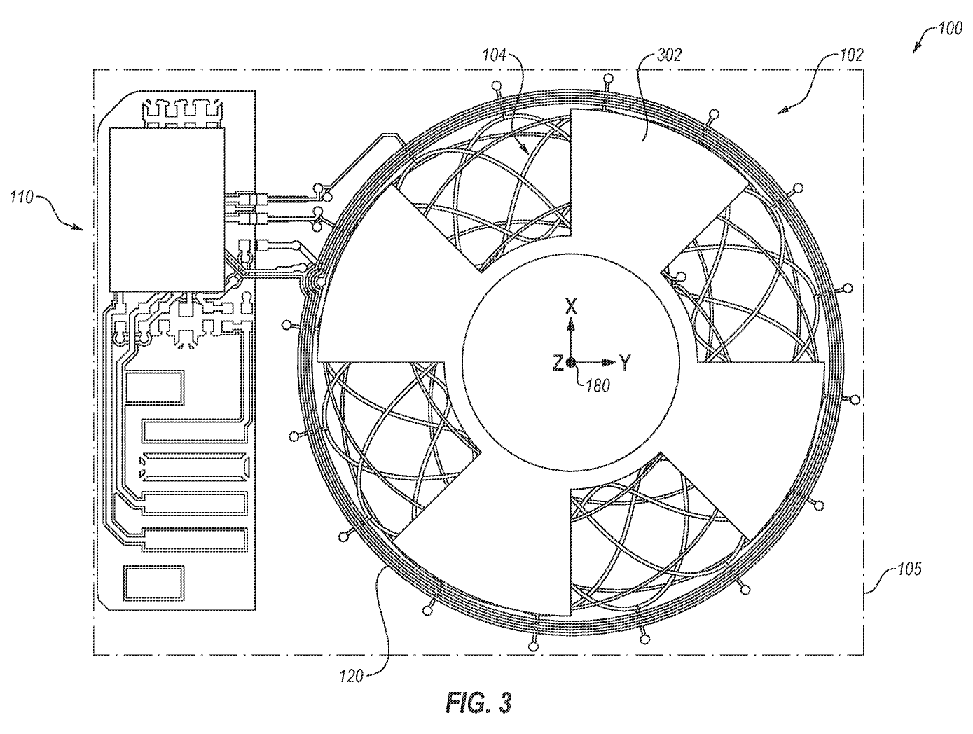

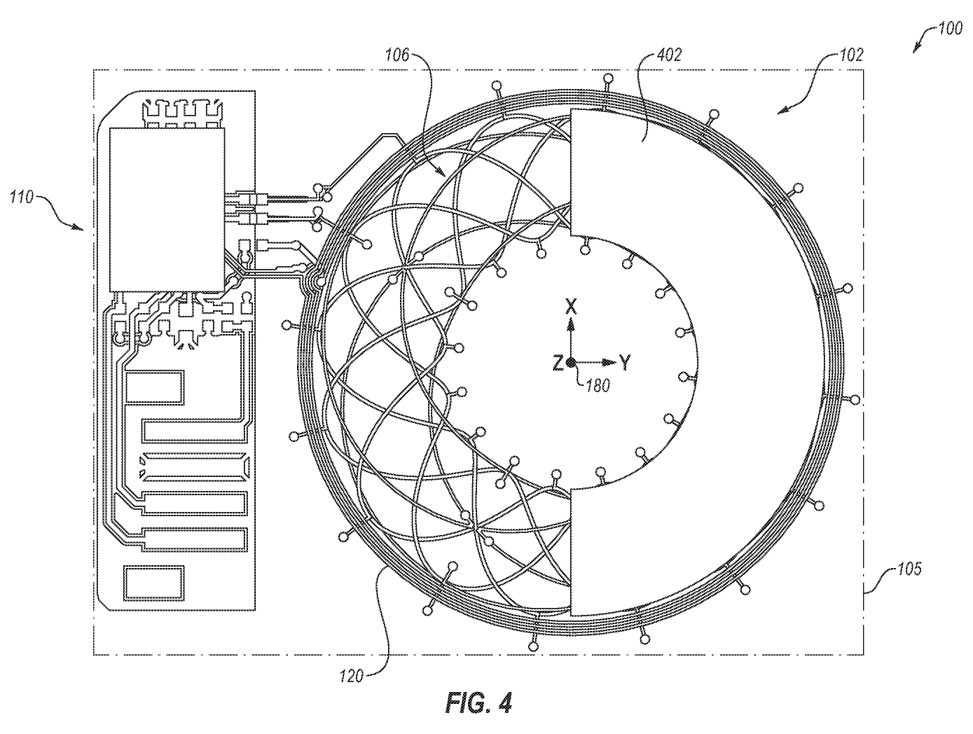

In one or more examples, apparatus 100 of FIGS. 1 and 2 is to sense or detect an angular position of a target (e.g., a target 302 of FIG. 3) adapted to rotate about an axis 180. Apparatus 100 of FIGS. 1 and 2 is to alternatively sense or detect an angular position of an alternative target (e.g., a target 402 of FIG. 4) adapted to rotate about axis 180. In the figures, axis 180 is shown as the Z-axis in a three-dimensional coordinate axis system (X-Y-Z).

Apparatus 100 of FIGS. 1 and 2 comprises a support structure 105 and planar coils 102 on, or in, support structure 105. In one or more examples, planar coils 102 comprise conductive traces on, or in, multiple layers of support structure 105. More particularly, planar coils 102 include one or more oscillator coils 120 having a circular winding pattern arranged around axis 180. One or more oscillator coils 120 may be referred to as one or more primary coils. Planar coils 102 also include a set of coils 104 for inductive angular position sensing over an angular position measurement range associated with the target (e.g., target 302 of FIG. 3). Planar coils 102 further include an additional set of coils 106 for alternative inductive angular position sensing over an alternative angular position measurement range associated with the alternative target (e.g., target 402 of FIG. 4). Each one of set of coils 104 and additional set of coils 106 may be referred to as secondary coils.

In one or more examples, the planar coils including one or more oscillator coils 120, set of coils 104, and additional set of coils 106, may be at least partially formed by conductive traces on and/or in one or more layers (e.g., multiple layers or planes) of support structure 105. In one or more examples, support structure 105 may be or include a substrate, such as a printed circuit board (PCB). When multiple planes are used for coil arrangements, the multiple planes may be parallel planes at different heights of the substrate. For example, a respective one of the multiple planes may be associated with a different one of multiple layers of a PCB.

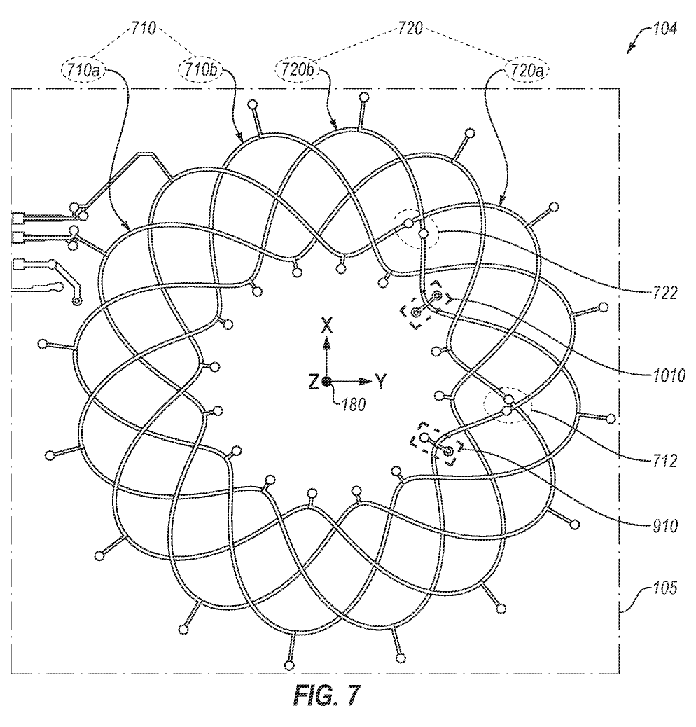

FIG. 3 is a top-down view of apparatus 100 including target 302 which is set or operationally situated about axis 180 for rotation for angular-position sensing via set of coils 104, according to one or more examples. For inductive angular position sensing of target 302, set of coils 104 includes first and second sense coils (which are more clearly depicted and described later in relation to FIG. 7 as first and second sense coils 710 and 720). Respective ones of the first and the second sense coils of set of coils 104 of FIG. 3 define M pole pairs for the inductive angular position sensing of target 302. Here, in one or more examples, target 302 of FIG. 3 has a target body that is generally planar (i.e., in-plane with the page) and circular, defining an M pole pair pattern with M fins about axis 180.

In the specific, non-limiting example of FIG. 3, M=4, and therefore respective ones of the first and the second sense coils define a four (4) pole pair sensor where target 302 has four (4) fins. In one or more examples, the M fins are equally circumferentially spaced about axis 180 at about 360/M degree intervals (e.g., 360/4 = 90 degree intervals), and respective ones of the M fins have an arc length defined by an angle of about 180/M degrees (e.g., 180/4 = 45 degrees) with 180/M degree apertures between respective adjacent fins or fin edges. Here, the angular position measurement range of the sensor is 360/M degrees, and more specifically, 360/4 = 90 degrees, or providing a 90 degree measurement range.

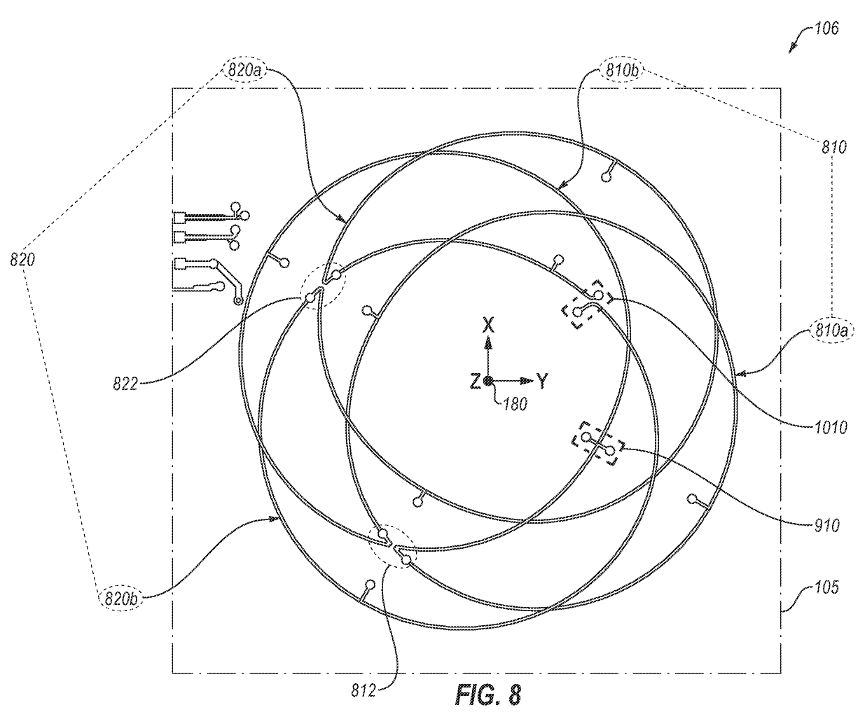

FIG. 4 is a top-down view of apparatus 100 including target 402 which is set or operationally situated about axis 180 for rotation for angular-position sensing via additional set of coils 106, according to one or more examples. For inductive angular position sensing of target 402, additional set of coils 106 includes additional first and second sense coils (which are more clearly depicted and described later in relation to FIG. 8 as additional first and second sense coils 810 and 820). Respective ones of the additional first and second sense coils of additional set of coils 106 of FIG. 4 define one or more N pole pairs for the inductive angular position sensing of target 402. Here, in one or more examples, target 402 of FIG. 4 has a target body that is generally planar (i.e., in-plane with the page) and half circular, defining an N pole pair pattern with one or more N fins about axis 180.

In the specific, non-limiting example of FIG. 4, N=1, and therefore respective ones of the additional first and second sense coils define a one (1) pole pair sensor where target 402 has one (1) fin. In one or more examples, the one or more N fins are equally circumferentially spaced about axis 180 at about 360/N degree intervals (e.g., 360/1 = 360 degree intervals), and respective ones of the N fins have an arc length defined by an angle of about 180/M degrees (e.g., 180/1 = 180 degrees) with 180/N degree apertures between respective adjacent fins or fin edges. Here, the angular position measurement range of the sensor is 360/N degrees, and more specifically, 360/1 = 360 degrees, or providing a 360 degree measurement range.

Respective ones of the target body may be made of a conductive material, such as a non-magnetic conductive metal or metal alloy, without limitation. In one or more examples, the non-magnetic conductive metal or metal alloy may be or include copper or aluminum. In one or more other examples, the target body may be made of a magnetic conductive metal or metal alloy, such as carbon steel or ferritic stainless steel, without limitation. Here, an oscillator may generate an excitation signal within a certain range of frequencies (e.g., 1-6 MHz, without limitation) that the magnetic domains of the magnetic conductive metals or metal alloys will not react to.

Accordingly, in view of the examples of FIGS. 3 and 4, apparatus 100 is to sense inductive angular position signals associated with an angular position of target 302 of FIG. 3 when target 302 is set or operationally situated about axis 180, and/or to sense inductive angular position signals associated with an angular position of (alternative) target 402 of FIG. 4 when (alternative) target 402 is set or operationally situated about axis 180.

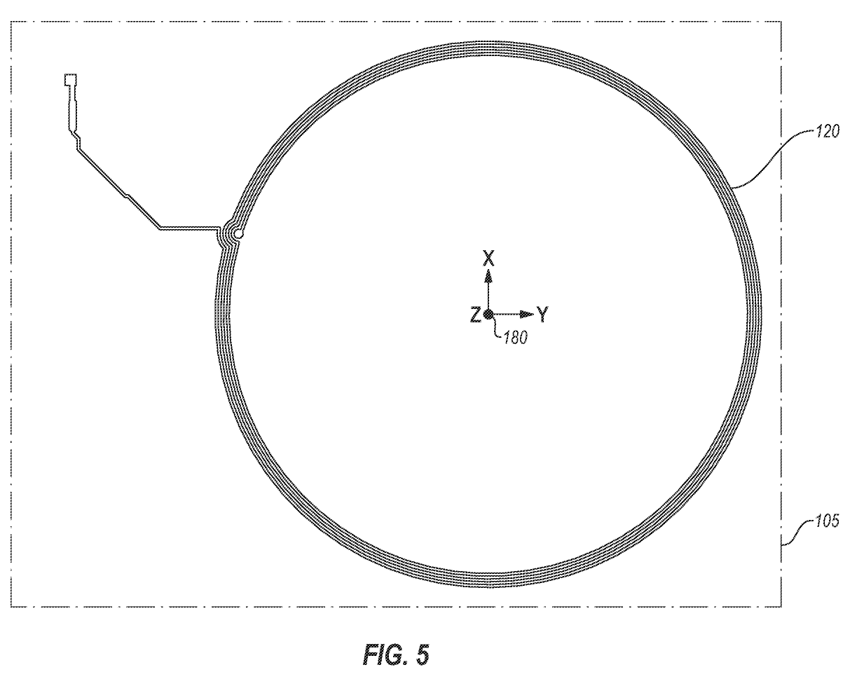

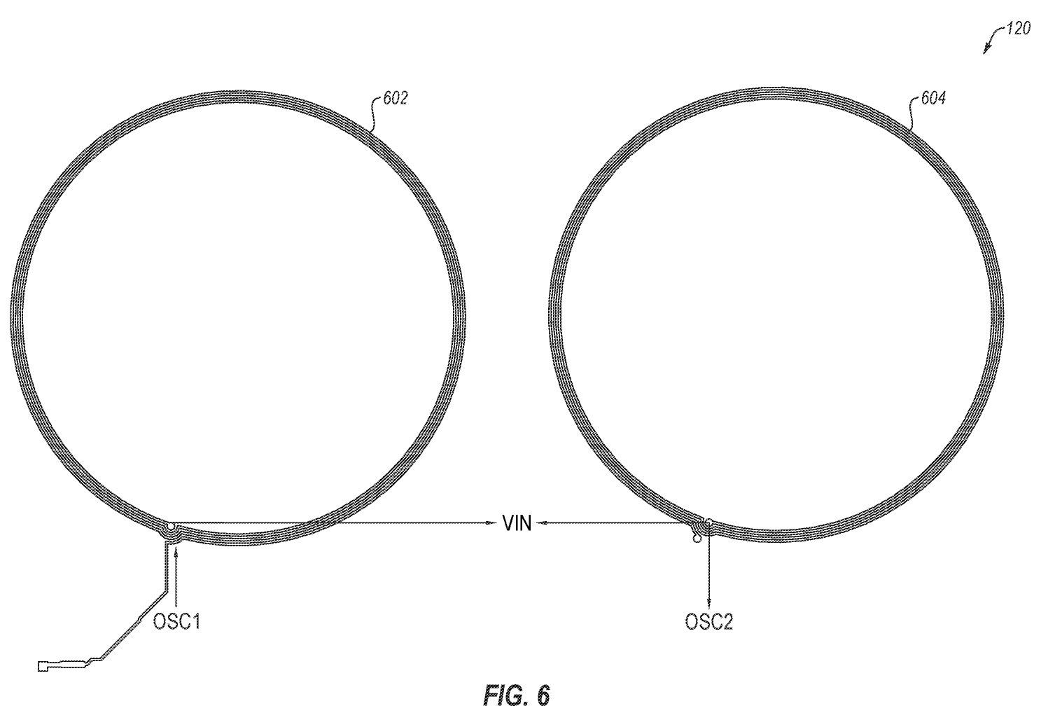

Again, planar coils 102 include one or more oscillator coils 120 for producing a varying magnetic field to induce sense signals in the sense coils (i.e., set of coils 104 and additional set of coils 106). FIG. 5 is a top-down view of one or more oscillator coils 120 with the other coils removed for illustrative clarity. In one or more specific examples, one or more oscillator coils 120 include a first oscillator coil and a second oscillator coil, which are overlaid with, coextensive with, and/or positioned adjacent to each other as depicted in FIG. 5. To better appreciate the first and second oscillator coil arrangement, FIG. 6 is a top-down view of one or more oscillator coils 120 which include a first oscillator coil 602 and a second oscillator coil 604, shown physically separated from each other for illustrative clarity, and indicated as being coupled to a common center tap (e.g., V_{IN}). For generating the fluctuating magnetic field, an excitation circuitry generates a first excitation signal in first oscillator coil 602 and a second excitation signal in second oscillator coil 604, where the second excitation signal is substantially 180 degrees out of phase with the first excitation signal.

FIG. 7 depicts set of coils 104 including a first sense coil 710 and a second sense coil 720, with the other coils removed for illustrative clarity, according to one or more examples. First and second sense coils 710 and 720 may be referred to as secondary coils. Respective ones of first and second sense coils 710 and 720 define M pole pairs (e.g., where M=4) for angular position sensing of the target (e.g., target 302 of FIG. 3). In one or more examples, one or more oscillator coils 120 (FIGS. 1-6) may be used to generate the fluctuating magnetic field for inducing sense signals in first and second sense coils 710 and 720 (e.g., as well as for inducing in additional set of coils 106 of FIG. 8).

FIG. 8 depicts additional set of coils 106 including an additional first sense coil 810 and an additional second sense coil 820, with the other coils removed for illustrative clarity, according to one or more examples. Additional first and second sense coils 810 and 820 may be referred to as additional secondary coils. Additional first and second sense coils 810 and 820 define one or more N pole pairs (e.g., where N=1) for angular position sensing of the alternative target (e.g., target 402 of FIG. 4). In one or more examples, one or more oscillator coils 120 (FIGS. 1-6) may be used to generate the fluctuating magnetic field for inducing sense signals in additional first and second sense coils 810 and 820 (e.g., as well as for inducing in set of coils 104 of FIG. 7). In other examples, one or more additional oscillator coils (i.e., separate from one or more oscillator coils 120) may be used to generate the fluctuating magnetic field for inducing sense signals in additional set of coils 106.

When apparatus 100 of FIGS. 1-2 is in operational use with target 302 of FIG. 3, target 302 rotates about axis 180 (e.g., the target may be connected to a through-shaft, which may extend through support structure 105). Target 302 may disrupt magnetic coupling between one or more oscillator coils 120 and the first and the second sense coils (e.g., first and the second sense coils 710 and 720 of FIG. 7), such that sense signals induced in the sense coils are indicative of an angular position of target 302 as it rotates about axis 180. The degree to which target 302 disrupts magnetic coupling between one or more oscillator coils 120 and the first and the second sense coils may vary at least partially in response to changes in the angular position of target 302.

Similarly, when apparatus 100 of FIGS. 1-2 is in operational use with target 402 of FIG. 4, target 402 rotates about axis 180 (e.g., the alternative target may alternatively be connected to the through-shaft, which may extend through support structure 105). Target 402 may disrupt magnetic coupling between one or more oscillator coils 120 and the additional first and the second sense coils (e.g., additional first and the second sense coils 810 and 820 of FIG. 8), such that sense signals induced in the additional sense coils are indicative of an angular position of target 402 as it rotates about axis 180. The degree to which target 402 disrupts magnetic coupling between one or more oscillator coils 120 and the additional first and the second sense coils may vary at least partially in response to changes in the angular position of target 402.

For angular position sensing of the target, the inductive angular position sensor may include a position sensing circuitry 110 (FIGS. 1-4). In one or more examples, position sensing circuitry 110 of the inductive angular position sensor may be or include a sensor IC. Position sensing circuitry 110 (e.g., the sensor IC) may also be disposed on a substrate, such as a PCB, which may or may not be an extension of support structure 105. In an example contemplated operation, position sensing circuitry 110 generates a high-frequency signal to excite one or more oscillator coils 120 for producing an alternating magnetic field. The alternating magnetic field couples onto the sense coils for generating a voltage. As the target disturbs the generated magnetic field, the sense coils will receive different voltages versus target position. When there is no target, voltage induced in the sense coils will be zero. When the target is present and is rotating, it creates modulated sine and cosine waveforms given as feedback signals to position sensing circuitry 110 (e.g., the IC). Internal to the IC, the signals are de-modulated, and position information may be calculated, for example, by taking an arctan2 function of the ratio of the two sense signals, which may be sine and cosine signals.

With reference back to FIG. 7, set of coils 104 includes first and second sense coils 710 and 720 for defining an M pole pair sensing apparatus for angular position sensing of the target (e.g., target 302 of FIG. 3, where M=4). In FIG. 7, first sense coil 710 includes a forward coil path 710a defining M in-phase lobes circumferentially arranged about axis 180. Forward coil path 710a defines a first path (e.g., a substantially-sinusoidal-wave-shaped path around axis 180) for electrical current to flow in a first direction (e.g., a clockwise direction) around axis 180. First sense coil 710 further includes a return coil path 710b defining M out-of-phase lobes circumferentially arranged about axis 180. Return coil path 710b defines a second path (e.g., a substantially-sinusoidal-wave-shaped path around axis 180) for the electrical current to flow in a second direction (e.g., a counter-clockwise direction) around axis 180. Respective ones of in-phase lobes and the out-of-phase lobes of first sense coil 710 have peak and valley portions extending between respective outer and inner circles of an annulus.

For connecting forward and return coil paths 710a and 710b, first sense coil 710 includes first and second crossover connections located in a first inter-lobe region 712. First inter-lobe region 712 is a region in which an in-phase lobe of forward coil path 710a of first sense coil 710 meets with an out-of-phase lobe of return coil path 710b of first sense coil 710. The first crossover connection in first inter-lobe region 712 connects an ending portion of the in-phase lobe of forward coil path 710a of first sense coil 710 to a starting portion of the out-of-phase lobe of return coil path 710b of first sense coil 710. The second crossover connection in first inter-lobe region 712 connects an ending portion of the out-of-phase lobe of return coil path 710b of first sense coil 710 to a starting portion of the in-phase lobe of forward coil path 710a of first sense coil 710.

Second sense coil 720 includes a forward coil path 720a defining M in-phase lobes circumferentially arranged about axis 180. Forward coil path 720a defines a first path (e.g., a substantially-sinusoidal-wave-shaped path around axis 180) for electrical current to flow in the first direction (e.g., the clockwise direction) around axis 180. Second sense coil 720 further includes a return coil path 720b defining M out-of-phase lobes circumferentially arranged about axis 180. Return coil path 720b defines a second path (e.g., a substantially-sinusoidal-wave-shaped path around axis 180) for electrical current to flow in the second direction (e.g., the counter-clockwise direction) around axis 180. Respective ones of in-phase lobes and the out-of-phase lobes of second sense coil 720 have peak and valley portions extending between respective outer and inner circles of the annulus.

For connecting forward and return coil paths 720a and 720b, second sense coil 720 includes third and fourth crossover connections located in a second inter-lobe region 722. Second inter-lobe region 722 is a region in which an in-phase lobe of forward coil path 720a of second sense coil 720 meets with an out-of-phase lobe of return coil path 720b of second sense coil 720. The third crossover connection in second inter-lobe region 722 connects an ending portion of the in-phase lobe of forward coil path 720a of second sense coil 720 to a starting portion of the out-of-phase lobe of return coil path 720b of second sense coil 720. The fourth crossover connection in second inter-lobe region 722 connects an ending portion of the out-of-phase lobe of return coil path 720b of second sense coil 720 to a starting portion of the in-phase lobe of forward coil path 720a of second sense coil 720.

In one or more examples, respective ones of the M in-phase lobes of forward coil path 710a of first sense coil 710 are circumferentially arranged to be 180/M degrees out of phase with respective adjacent ones of the M out-of-phase lobes of return coil path 710b of first sense coil 710 (e.g., where M=4, 180/4 = 45 degrees out of phase, as measured from lobe peak to lobe peak). In one or more examples, respective ones of the M in-phase lobes of forward coil path 720a of second sense coil 720 are circumferentially arranged to be 180/M degrees out of phase with respective adjacent ones of the M out-of-phase lobes of return coil path 720b of second sense coil 720 (e.g., again where M=4, 180/4 = 45 degrees out of phase, as measured from lobe peak to lobe peak). In one or more examples, respective ones of 2*M lobes of first sense coil 710 are circumferentially arranged to be 90/M out of phase with respective adjacent ones of 2*M lobes of second sense coil 720 (e.g., where M=4, 90/4 = 22.5 degrees out of phase, as measured from lobe peak to lobe peak). In one or more examples, respective lobes of first sense coil 710 are arranged to be out of phase with respective lobes of second sense coil 720 so as to produce sinusoidal wave signals that are 90 degrees out of phase with each other.

With reference back to FIG. 8, additional set of coils 106 includes additional first and second sense coils 810 and 820 for defining an N pole pair sensing apparatus for angular position sensing of the alternative (e.g., target 402 of FIG. 4, where N=1). In FIG. 8, additional first sense coil 810 includes a forward coil path 810a defining one or more N in-phase lobes circumferentially arranged about axis 180. Additional first sense coil 810 further includes a return coil path 810b defining one or more N out-of-phase lobes circumferentially arranged about axis 180. For connecting forward and return coil paths 810a and 810b, additional first sense coil 810 includes first and second crossover connections located in a first inter-lobe region 812. First inter-lobe region 812 is a region in which an in-phase lobe of forward coil path 810a of additional first sense coil 810 meets with an out-of-phase lobe of return coil path 810b of additional first sense coil 810. The first crossover connection in first inter-lobe region 812 connects an ending portion of the in-phase lobe of forward coil path 810a of additional first sense coil 810 to a starting portion of the out-of-phase lobe of return coil path 810b of additional first sense coil 810. The second crossover connection in first inter-lobe region 812 connects an ending portion of the out-of-phase lobe of return coil path 810b of additional first sense coil 810 to a starting portion of the in-phase lobe of forward coil path 810a of additional first sense coil 810.

Additional second sense coil 820 includes a forward coil path 820a defining one or more N in-phase lobes circumferentially arranged about axis 180. Additional second sense coil 820 further includes a return coil path 820b defining one or more N out-of-phase lobes circumferentially arranged about axis 180. For connecting forward and return coil paths 820a and 820b, additional second sense coil 820 further includes third and fourth crossover connections located in a second inter-lobe region 822. Second inter-lobe region 822 is a region in which an in-phase lobe of forward coil path 820a of additional second sense coil 820 meets with an out-of-phase lobe of return coil path 820b of additional second sense coil 820. The third crossover connection in second inter-lobe region 822 connects an ending portion of the in-phase lobe of forward coil path 820a of additional second sense coil 820 to a starting portion of the out-of-phase lobe of return coil path 820b of additional second sense coil 820. The fourth crossover connection in second inter-lobe region 822 connects an ending portion of the out-of-phase lobe of return coil path 820b of additional second sense coil 820 to a starting portion of the in-phase lobe of forward coil path 820a of additional second sense coil 820.

In one or more examples, respective ones of the one or more N in-phase lobes of forward coil path 810a of additional first sense coil 810 are circumferentially arranged to be 180/N degrees out of phase with respective adjacent ones of the one or more N out-of-phase lobes of return coil path 810b of additional first sense coil 810 (e.g., where N=1, 180/1 = 180 degrees out of phase, as measured from lobe peak to lobe peak). In one or more examples, respective ones of the one or more N in-phase lobes of forward coil path 820a of additional second sense coil 820 are circumferentially arranged to be 180/N degrees out of phase with respective adjacent ones of the one or more N out-of-phase lobes of return coil path 820b of additional second sense coil 820 (e.g., again where N=1, 180/1 = 180 degrees out of phase, as measured from lobe peak to lobe peak). In one or more examples, respective ones of 2*N lobes of additional first sense coil 810 are circumferentially arranged to be 90/N degrees out of phase with respective adjacent ones of 2*N lobes of additional second sense coil 820 (e.g., where N=1, 90/1 = 90 degrees out of phase, as measured from lobe peak to lobe peak). In one or more examples, respective lobes of additional first sense coil 810 are arranged to be out of phase with respective lobes of additional second sense coil 820 so as to produce sinusoidal wave signals that are 90 degrees out of phase with each other.

In one or more examples, M > N ≥ 1. In one or more examples, M is a positive even integer, and N is a positive odd integer. In one or more examples, M is greater than or equal to four (4), and N is equal to one (1). In a specific, non-limiting example of FIGS. 7 and 8, M = 4 and N = 1.

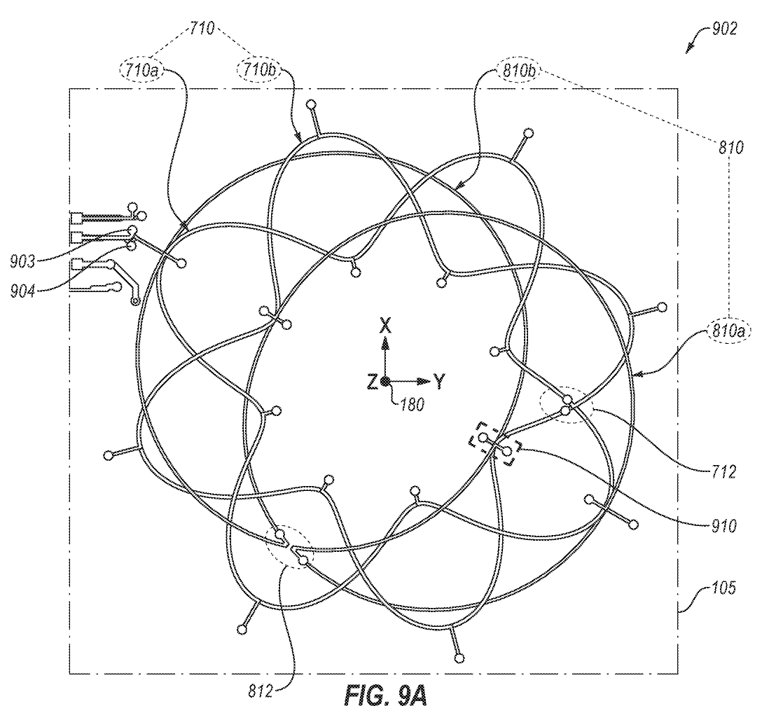

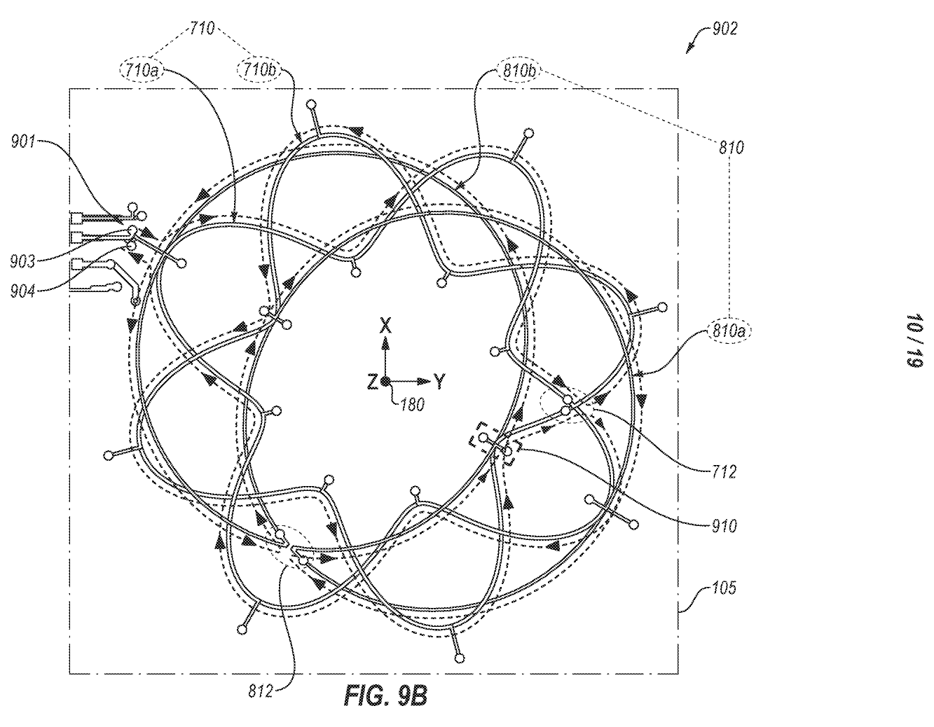

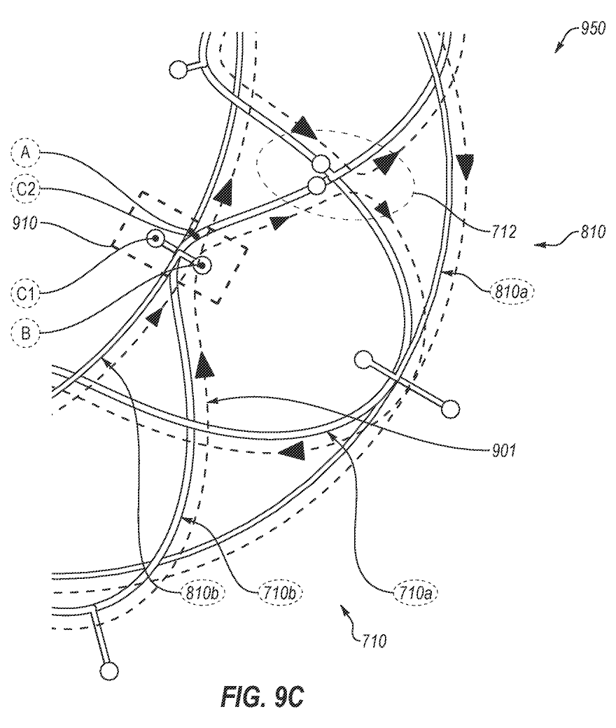

As discussed earlier, in one or more examples, planar coils 102 including one or more oscillator coils 120, set of coils 104, and additional set of coils 106 are provided on and/or in multiple layers of support structure 105 (e.g., a PCB). In one or more specific examples, planar coils 102 may be provided on and/or in first, second, third, and fourth layers of support structure 105 (e.g., the PCB). In one or more examples, set of coils 104 may be provided in the first and the second layers of support structure 105; additional set of coils 106 may be provided in the third and the fourth layers of support structure 105; and one or more oscillator coils 120 may be provided in the fourth layer (e.g., shared with additional set of coils 106) of support structure 105. In one or more specific examples, respective ones of first sense coil 710 and second sense coil 720 of FIG. 7 alternate between the first and the second layers of support structure 105, at respective peak and valley portions of the multiple lobes, through respective conductive vias. In addition, respective ones of additional first sense coil 810 and additional second sense coil 820 of FIG. 8 also alternate between the third and the fourth layers of support structure 105, at respective peak and valley portions of the multiple lobes, through respective conductive vias. Note that the actual flow and path connections from layer to layer include that shown and described below in relation to FIGS. 9B and/or 10B (i.e., the cascaded sense coil arrangements).

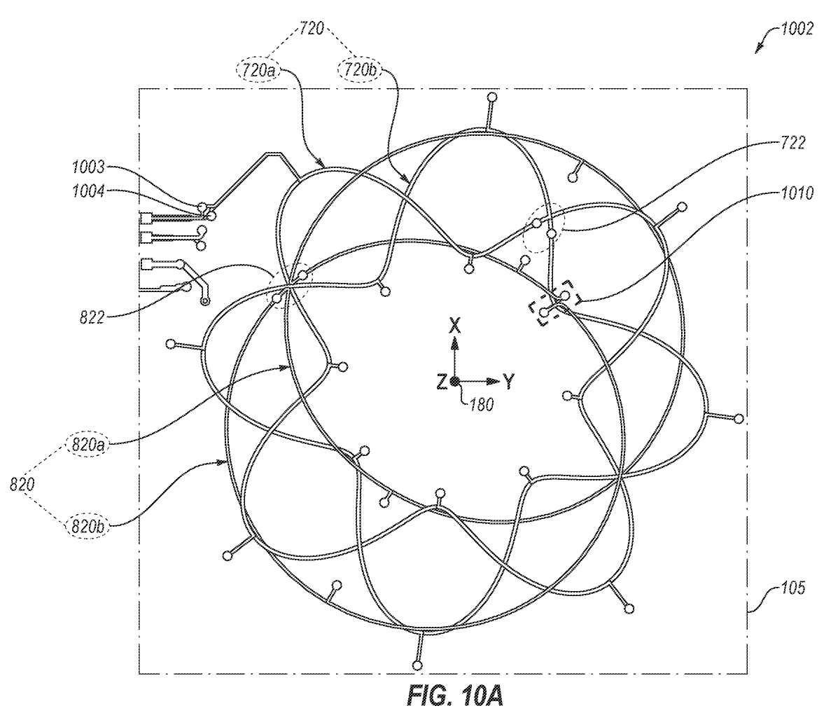

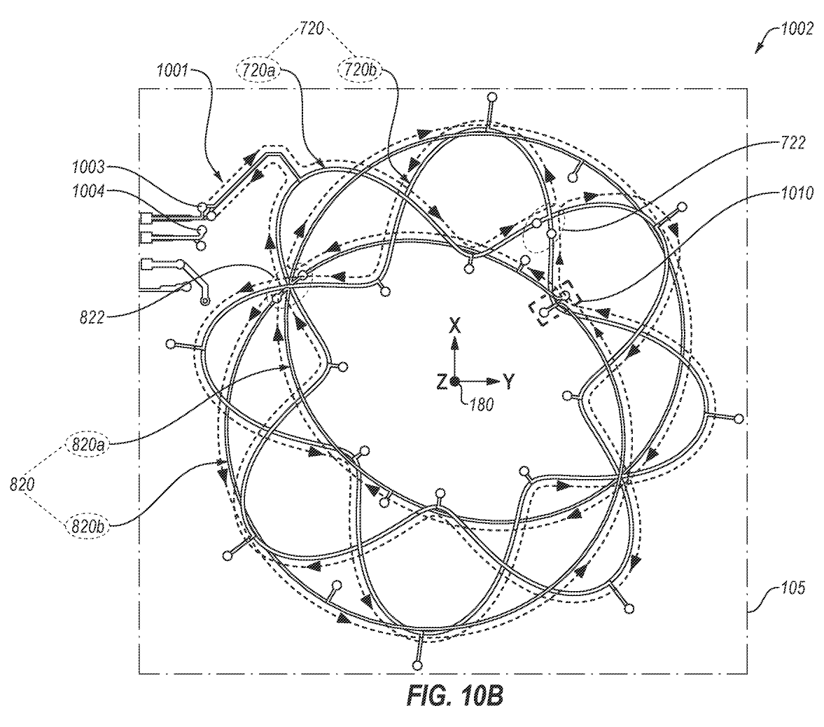

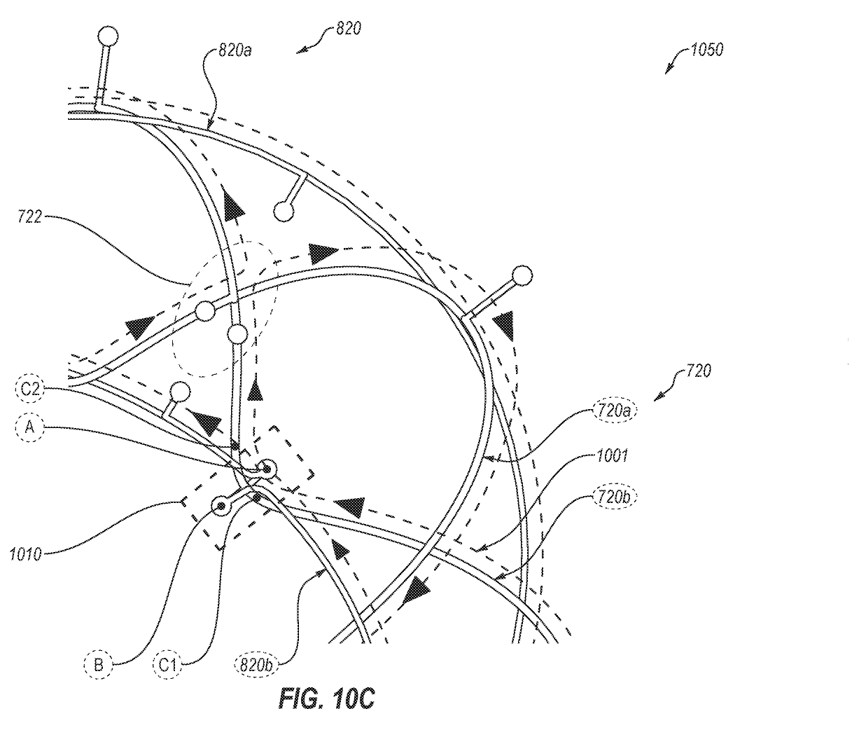

According to one or more examples of the disclosure, the planar coils of FIGS. 7 and 8 are arranged and/or constructed as two different cascaded sense coil arrangements. More specifically, the planar coils of FIGS. 7 and 8 are arranged and/or constructed as a first cascaded sense coil arrangement 902 of FIGS. 9A, 9B, and 9C and a second cascaded sense coil arrangement 1002 of FIGS. 10A, 10B, and 10C. Depending on the context, a cascaded sense coil arrangement (e.g., sense coils arranged in series) may be alternatively referred to as a cascaded sense coil structure, cascaded sense coil windings, cascaded sense coils, or connected sense coils, to name but a few.

FIG. 9A depicts a first cascaded sense coil arrangement 902 including first sense coil 710 (e.g., of the set of coils 104 of FIG. 7) and additional first sense coil 810 (e.g., of the additional set of coils 106 of FIG. 8), according to one or more examples. First sense coil 710 is for inductive angular position sensing over an angular position measurement range (e.g., 360/M degrees, in relation to target 302 of FIG. 3) and additional first sense coil 810 is for additional inductive angular position sensing over an additional angular position measurement range (e.g., 360/N degrees, in relation to target 402 of FIG. 4). As will be discussed below, in first cascaded sense coil arrangement 902, additional first sense coil 810 is connected in series between first and second coil segments of first sense coil 710.

First sense coil 710 includes forward coil path 710a defining the M in-phase lobes circumferentially arranged about axis 180. First sense coil 710 further includes return coil path 710b defining the M out-of-phase lobes circumferentially arranged about axis 180. First sense coil 710 includes the first and the second crossover connections in first inter-lobe region 712 that connect forward and return coil paths 710a and 710b.

Additional first sense coil 810 includes forward coil path 810a defining the one or more N in-phase lobes circumferentially arranged about axis 180. Additional first sense coil 810 further includes return coil path 810b defining the one or more N out-of-phase lobes circumferentially arranged about axis 180. Additional first sense coil 810 includes the first and the second crossover connections in first inter-lobe region 812 that connect forward and return coil paths 810a and 810b.

In one or more examples, first cascaded sense coil arrangement 902 including first sense coil 710 and additional first sense coil 810 defines a continuous path between a first node 903 and a second node 904 (e.g., coupled to the position sensing circuitry, such as at CL1 input and coil ground input). First sense coil 710 has first and second ends respectively connected to first and second nodes 903 and 904. First node 903 may be or indicate an entry point to forward coil path 710a of first sense coil 710 in the continuous path, and second node 904 may be or indicate an exit point from forward coil path 710a of first sense coil 710 in the continuous path.

On the other hand, additional first sense coil 810 is connected in series between first and second coil segments of first sense coil 710 in a coil meeting region 910. In one or more examples, coil meeting region 910 is a region at which a peak or valley portion of a lobe of first sense coil 710 meets with a respective peak or valley portion of a lobe of additional first sense coil 810.

FIG. 9B depicts first cascaded sense coil arrangement 902 including first sense coil 710 and additional first sense coil 810 as shown in FIG. 9A, further indicating a continuous path 901 between first node 903 and second node 904 through first sense coil 710 and additional first sense coil 810, according to one or more examples. More particularly, continuous path 901 of first cascaded sense coil arrangement 902 between first node 903 and second node 904 through first sense coil 710 and additional first sense coil 810 is indicated as a dotted line with arrows indicating the direction of the path. Path connections are made from layer to layer of support structure 105 through electrically conductive vias (e.g., as indicated as small circular structures in the figures) (e.g., in first inter-lobe regions 712 and 812, coil meeting region 910, and so on). Continuous path 901 may indicate an example electrical current flow in the coil from start and end points of the position sensing circuitry.

FIG. 9C is a close-up view of a region 950 that surrounds coil meeting region 910 to better illustrate inter-coil connections of first cascaded sense coil arrangement 902. Additional first sense coil 810 is shown to include a first end (A) connected to a first connecting end (C1) of the first coil segment of first sense coil 710, and a second end (B) connected to a second connecting end (C2) of the second coil segment of first sense coil 710. As illustrated in FIG. 9C, the inter-coil connections may be made with respective conductive vias within coil meeting region 910 (e.g., as indicated by the two small circles therein). In one or more examples, the inter-coil connections include a first pair of inter-coil connections, including a first inter-coil connection to connect the first end (A) of additional first sense coil 810 (e.g., return coil path 810b thereof) and the first connecting end (C1) of the first coil path portion of first sense coil 710 (e.g., return coil path 710b thereof), and a second inter-coil connection to connect the second end (B) of additional first sense coil 810 (e.g., return coil path 810b thereof) and the second connecting end (C2) of the second coil path portion of first sense coil 710 (e.g., return coil path 710b thereof).

With reference to both FIGS. 9B and 9C, in a first pass though coil meeting region 910, the flow is from return coil path 710b of first sense coil 710 to return coil path 810b of additional first sense coil 810 (in FIG. 9C, from the first connecting end C1 of first sense coil 710 to the first end A of additional first sense coil 810). In a second pass though coil meeting region 910, the flow is from return coil path 810b of additional first sense coil 810 to return coil path 710b of first sense coil 710 (in FIG. 9C, from the second end B of additional first sense coil 810 to the second connecting end C2 of first sense coil 710).

FIG. 10A depicts a second cascaded sense coil arrangement 1002 including second sense coil 720 and additional second sense coil 820, according to one or more examples. Second sense coil 720 is for inductive angular position sensing over the angular position measurement range (e.g., 360/M degrees, in relation to target 302 of FIG. 3) and additional second sense coil 820 is for additional inductive angular position sensing over the additional angular position measurement range (e.g., 360/N degrees, in relation to target 402 of FIG. 4). As will be discussed below, in second cascaded sense coil arrangement 1002, additional second sense coil 820 is connected in series between first and second coil segments of second sense coil 720.

Second sense coil 720 includes forward coil path 720a defining the M in-phase lobes circumferentially arranged about axis 180. Second sense coil 720 further includes return coil path 720b defining the M out-of-phase lobes circumferentially arranged about axis 180. Second sense coil 720 includes the third and the fourth crossover connections in second inter-lobe region 722 that connect forward and return coil paths 720a and 720b of second sense coil 720.

Additional second sense coil 820 includes forward coil path 820a defining the one or more N in-phase lobes circumferentially arranged about axis 180. Additional second sense coil 820 further includes return coil path 820b defining the one or more N out-of-phase lobes circumferentially arranged about axis 180. Additional first sense coil 810 includes the third and the fourth crossover connections in second inter-lobe region 822 that connect forward and return coil paths 820a and 820b.

In one or more examples, second cascaded sense coil arrangement 1002 including second sense coil 720 and additional second sense coil 820 defines a continuous path between a third node 1003 and a fourth node 1004 (e.g., coupled to the position sensing circuitry, such as at CL2 input and the coil ground input). Second sense coil 720 has first and second ends respectively connected to third and fourth nodes 1003 and 1004. Third node 1003 may be or indicate an entry point to forward coil path 720a of second sense coil 720 in the continuous path, and fourth node 1004 may be or indicate an exit point from forward coil path 720a of second sense coil 720 in the continuous path.

On the other hand, additional second sense coil 820 is connected in series between the first and the second coil segments of second sense coil 720 in a coil meeting region 1010. In one or more examples, coil meeting region 1010 is a region at which a peak or valley portion of a lobe of second sense coil 720 meets with a respective peak or valley portion of a lobe of additional second sense coil 820.

FIG. 10B depicts first cascaded sense coil arrangement 902 including second sense coil 720 and additional second sense coil 820 as shown in FIG. 10A, and further indicating a continuous path 1001 between third node 1003 and fourth node 1004 through second sense coil 720 and additional second sense coil 820, according to one or more examples. More particularly, continuous path 1001 of second cascaded sense coil arrangement 1002 between third node 1003 and fourth node 1004 through second sense coil 720 and additional second sense coil 820 is indicated as a dotted line with arrows indicating the direction of the path. Path connections are made from layer to layer of support structure 105 through electrically conductive vias (e.g., as indicated as small circular structures in the figures) (e.g., in second inter-lobe regions 722 and 822, coil meeting region 1010, and so on). Continuous path 1001 may indicate an example electrical current flow in the coil from start and end points of the position sensing circuitry.

FIG. 10C is a close-up view of a region 1050 that surrounds coil meeting region 1010 to better illustrate inter-coil connections of second cascaded sense coil arrangement 1002. Additional second sense coil 820 is shown to include a first end (A) connected to a first connecting end (C1) of the first coil path portion of second sense coil 720, and a second end (B) connected to a second connecting end (C2) of the second coil path portion of second sense coil 720. As illustrated in FIG. 10C, the inter-coil connections may be made with respective conductive vias within coil meeting region 1010 (e.g., as indicated by the two small circles therein). In one or more examples, the inter-coil connections include a second pair of inter-coil connections, including a first inter-coil connection to connect the first end (A) of additional first sense coil 810 (e.g., return coil path 820b thereof) and the first connecting end (C1) of the first coil path portion of first sense coil 710 (e.g., return coil path 720b thereof), and a second inter-coil connection to connect the second end (B) of additional first sense coil 810 (e.g., return coil path 820b thereof) and the second connecting end (C2) of the second coil path portion of first sense coil 710 (e.g., return coil path 720b thereof).

With reference to both FIGS. 10B and 10C, in a first pass though coil meeting region 1010, the flow is from return coil path 720b of second sense coil 720 to return coil path 820b of additional second sense coil 820 (e.g., in FIG. 10C, from the first connecting end C1 of second sense coil 720 to the first end A of additional second sense coil 820). In a second pass though coil meeting region 1010, the flow is from return coil path 820b of additional second sense coil 820 to return coil path 720b of second sense coil 720 (e.g., in FIG. 10C, from the second end B of additional second sense coil 820 to the second connecting end C2 of second sense coil 720).

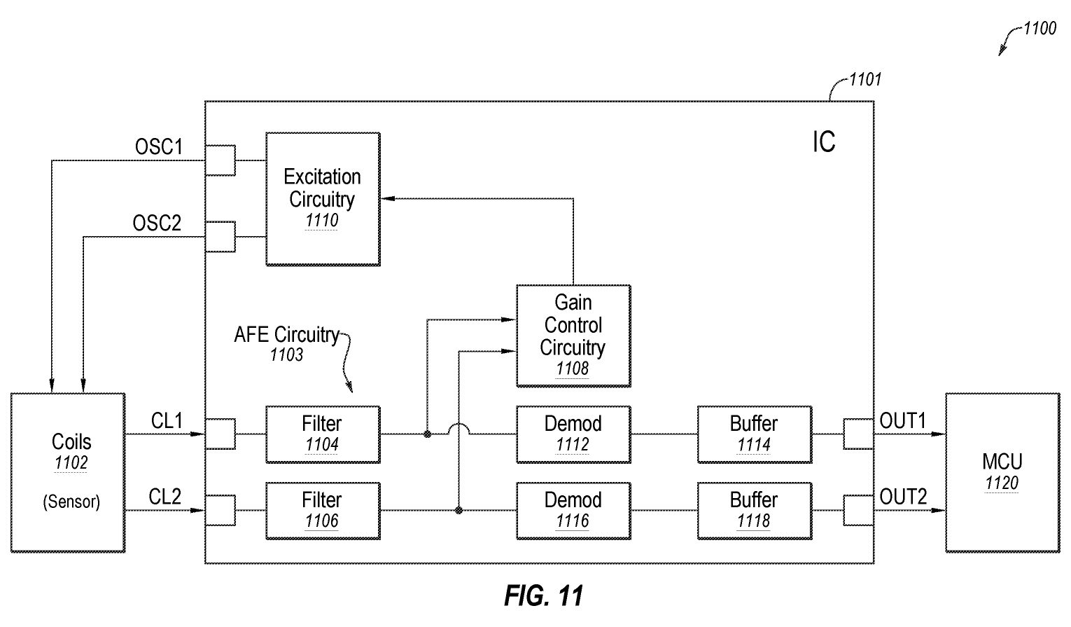

FIG. 11 is a schematic diagram of a position sensing circuitry 1100 for apparatus 100 of FIGS. 1-8, 9A-9C, and 10A-10C, according to one or more examples. Position sensing circuitry 1100 of FIG. 11 may be position sensing circuitry 110 of FIGS. 1-4. In one or more examples, position sensing circuitry 110 may be contained (in total or in part) in an IC 1101. In FIG. 11, the one or more oscillator coils, the first cascaded sense coil arrangement (FIGS. 9A-9C) including the first sense coil and the additional first sense coil, and the second cascaded sense coil arrangement (FIGS. 10A-10C) including the second sense coil and the additional second sense coil, are represented by coils 1102. In one or more examples, the position sensing circuitry may include two position sensing circuitry 1100, a first position sensing circuitry for the M pole pair sensing (e.g., for the target) and a second position sensing circuitry for the N pole pair sensing (e.g., for the alternative target).

In one or more examples, position sensing circuitry 1100 includes an excitation circuitry 1110, an analog front-end (AFE) circuitry 1103, and a gain control circuitry 1108. AFE circuitry 1103 may also include, for a modulated first sense signal from the first sense coil (and/or the additional first sense coil) (e.g., at a CL1 input), a filter 1104 (e.g., an EMI filter), a demodulator 1112, and a buffer circuit 1114. AFE circuitry 1103 may further include, for a modulated second sense signal from the second sense coil (and/or the additional second sense coil) (e.g., at a CL2 input), a filter 1106 (e.g., an EMI filter), a demodulator 1116, and a buffer circuit 1118. Gain control circuitry 1108 is used to adjust the signal gain of excitation circuitry 1110 based at least on the received/modulated first and second sense signals. Demodulated first and second position signals (e.g., indicating a position of the target) may be provided at OUT1 and OUT2 outputs of position sensing circuitry 1100 after passing through buffer circuits 1114 and 1118, respectively.

In general, first and second position signals are detected at least partially based on (demodulating) the modulated first and second sense signals from the first and the second sense coils (and/or the additional first and second sense coils) (e.g., at respective CL1 and CL2 inputs), respectively. More specifically, excitation circuitry 1110 generates one or more excitation signals in the one or more oscillator coils (e.g., at OSC1 and OSC2 outputs) to produce a varying magnetic field to induce the first and second sense signals in the first and second sense coils (and/or the additional first and second sense coils), respectively. The varying magnetic field may be disturbed in accordance with an angular position of the target which modulates the first and second sense signals. The modulated first and second sense signals are received from the first and second sense coils (and/or the additional first and second sense coils) at the inputs (e.g., the CL1 and CL2 inputs). AFE circuitry 1103 receives and processes these signals. In particular, the modulated first sense signal (at CL1 input) is filtered through filter 1104, demodulated by demodulator 1112 to produce the demodulated first position signal, and sent to the OUT1 output through buffer circuit 1114. The modulated second sense signal (at the CL2 input) is filtered through filter 1106, demodulated by demodulator 1116 to produce the demodulated second position signal, and sent to the output OUT2 through buffer circuit 1118.

In one or more examples, when position sensing circuitry 1100 includes a processor (e.g., a central processing unit (CPU)), position sensing circuitry 1100 may calculate the angular position of the target at least partially based on the demodulated first and second position signals (e.g., based on the arctan2 function provided above, without limitation). In one or more other examples, a microcontroller unit (MCU) 1120 or an electronic control unit (ECU) may receive the first and second position signals at the OUT1 and OUT 2 outputs, respectively, and calculate the angular position of the target at least partially based on the first and second position signals (e.g., based on the arctan2 function provided above, without limitation).

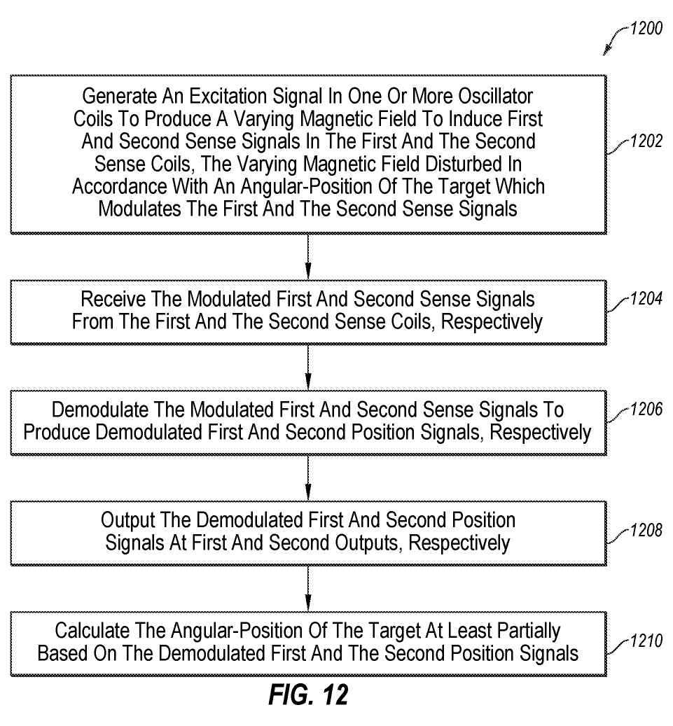

FIG. 12 is a flowchart of a method 1200 of inductive angular position sensing, according to one or more examples. In one or more examples, method 1200 may be performed with use of apparatus 100 of FIGS. 1-8, 9A-9C, and 10A-10C.

A rotatable target (e.g., target 302 of FIG. 3 for an M pole-pair sensor) is operationally situated or set about the axis of the sensing apparatus. Beginning at an act 1202, an excitation signal in one or more oscillator coils is generated to produce a varying magnetic field to induce first and second sense signals in first and second sense coils of a set of coils, respectively (e.g., set of coils 104 including first and second sense coils 710 and 720 of FIG. 7). The varying magnetic field may be disturbed in accordance with the angular position of the target which modulates the first and second sense signals. At an act 1204, the modulated first and second sense signals are received from the first and second sense coils, respectively. At an act 1206, the modulated first and second sense signals are demodulated to produce demodulated first and second position signals, respectively. Respective ones of the demodulated first and the second sense signals may exhibit one cycle for every 360/M degrees of rotation of the target (e.g., one cycle for every 360/4 degrees or 90 degrees of rotation). In one or more examples, the demodulated first and second position signals may be first and second voltage position signals (e.g., or differential signals). At an act 1208, the demodulated first and second position signals are output at first and second outputs, respectively. At an act 1210, the angular position of the target may be calculated at least partially based on the demodulated first and second position signals. In one or more examples, the angular position of the target may be calculated at least partially based on an arctan2 function (e.g., by taking an arctan2 function of the ratio of the two sense signals).

As an alternative to the above, or subsequent to the above, an alternative rotatable target (e.g., target 402 of FIG. 4 for an N pole-pair sensor) is operationally situated or set about the axis of the sensing apparatus. Repeating the acts of method 1200 using the alternative, different target, beginning again at act 1202, an excitation signal in one or more oscillator coils is generated to produce a varying magnetic field to induce additional first and second sense signals in additional first and second sense coils of an additional set of coils, respectively (e.g., additional set of coils 106 including additional first and second sense coils 810 and 820 of FIG. 8). The varying magnetic field may be disturbed in accordance with the angular position of the target which modulates the additional first and second sense signals. At act 1204, the modulated additional first and second sense signals are received from the additional first and second sense coils, respectively. At act 1206, the modulated additional first and second sense signals are demodulated to produce additional demodulated first and second position signals (or additional demodulated sense signals), respectively. Respective ones of the additional demodulated first and the second demodulated sense signals may exhibit one cycle for every 360/N degrees of rotation of the target (e.g., one cycle for every 360/1 degrees or 360 degrees of rotation). In one or more examples, the additional demodulated first and second position signals may be additional first and second voltage position signals (e.g., or differential signals). At act 1208, the additional demodulated first and second position signals are output at first and second outputs, respectively. At act 1210, the angular position of the target may be calculated at least partially based on the additional demodulated first and second position signals. In one or more examples, the angular position of the target may be calculated at least partially based on an arctan2 function (e.g., by taking an arctan2 function of the ratio of the two sense signals).

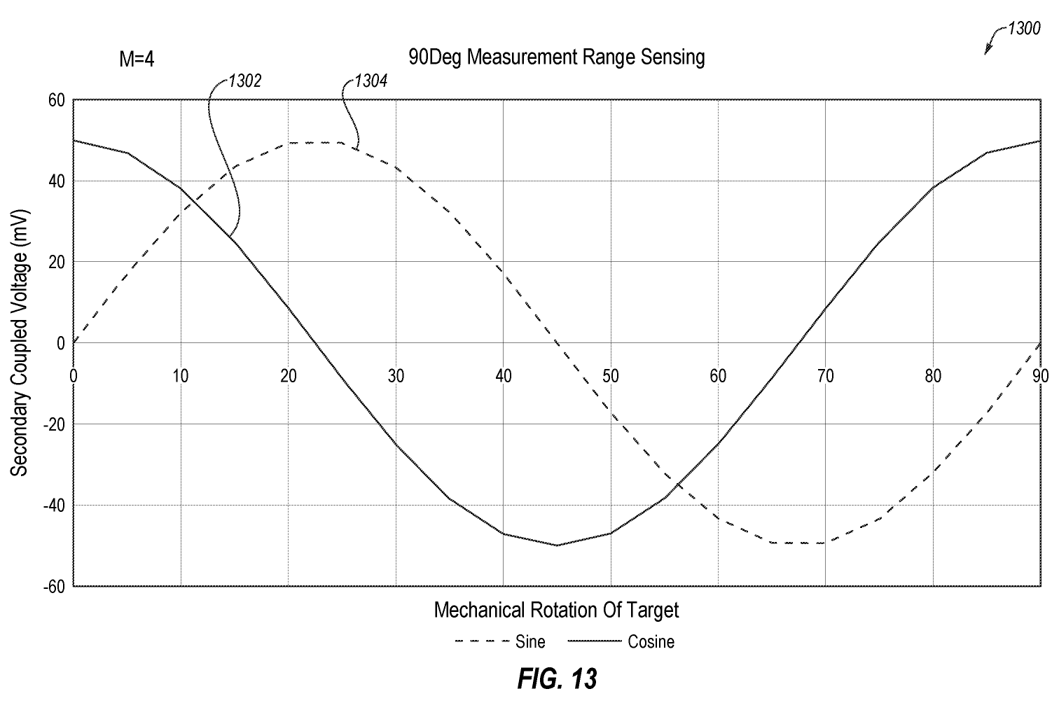

FIG. 13 is a graph 1300 of demodulated sense signals exhibited according to a simulation of operation of apparatus 100 of FIGS. 1-8, 9A-9C, 10A-10C, 11, and 12, according to one or more examples. The demodulated sense signals of graph 1300 may be exhibited from use of target 302 of FIG. 3 operationally situated or set about the axis of the sensing apparatus. In FIG. 13, a first demodulated sense signal 1302 (a first sinusoidal signal, such as a cosine signal) and a second demodulated sense signal 1304 (a second sinusoidal signal, such as a sine signal) are depicted. Here, second demodulated sense signal 1304 may be substantially 90 degrees out of phase with first demodulated sense signal 1302. Set of coils 104 of FIG. 7 including the first and the second sense coils for the M pole pair sensor is used for inductive sensing of the angular position of target 302 of FIG. 3 to provide an angular position measurement range of 360/M degrees (e.g., where M=4, 360/4 = 90 degrees). In one or more examples, respective ones of the first and the second demodulated sense signals 1302 and 1304 exhibit one cycle for every 360/M degrees (e.g., 90 degrees) of rotation of the target.

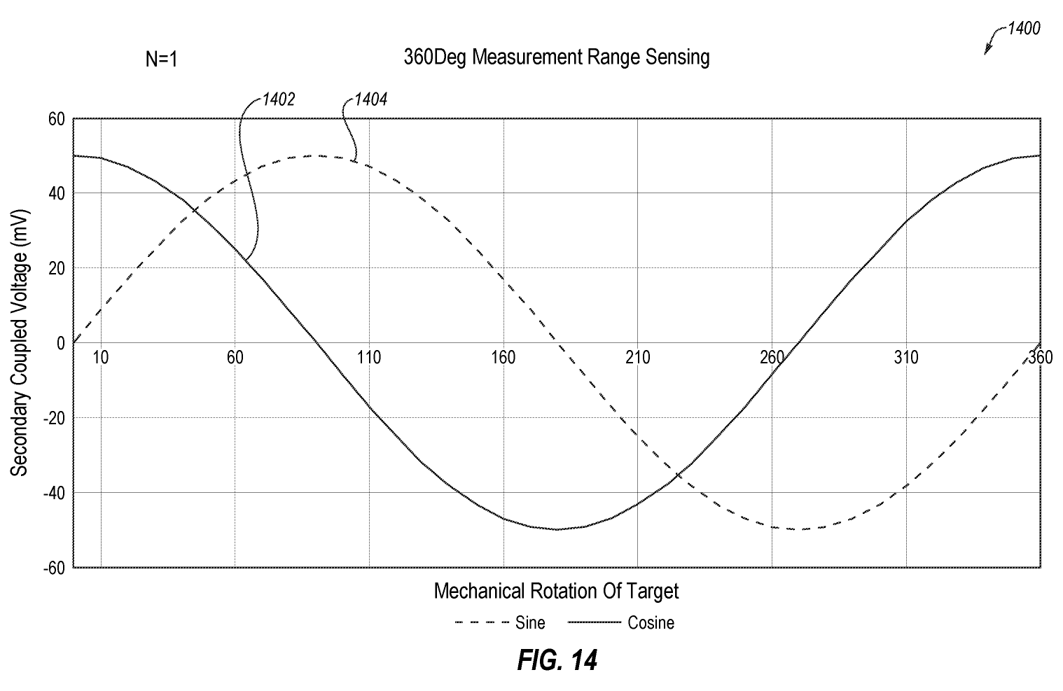

FIG. 14 is a graph 1400 of additional demodulated sense signals exhibited according to a simulation of the operation of apparatus 100 of FIGS. 1-8, 9A-9C, 10A-10C, 11, and 12, according to one or more examples. The additional demodulated sense signals of graph 1400 may be exhibited from use of target 402 of FIG. 4 operationally situated or set about axis 180 of the sensing apparatus. In FIG. 14, a third demodulated sense signal 1402 (a third sinusoidal signal, such as a cosine signal) and a fourth demodulated sense signal 1404 (a fourth sinusoidal signal, such as a sine signal) are depicted. Here, fourth demodulated sense signal 1404 may be substantially 90 degrees out of phase with third demodulated sense signal 1402. Set of coils 106 of FIG. 8 including the additional first and second sense coils for the N pole pair sensor are used for inductive sensing of the angular position of target 402 of FIG. 4 to provide an additional angular position measurement range of 360/N degrees (e.g., where N=1, 360/1 = 360 degrees). In one or more examples, respective ones of third and fourth demodulated sense signals 1402 and 1404 exhibit one cycle for every 360/N degrees (e.g., 360 degrees) of rotation of the target.

In one or more examples of the disclosure, the set of coils and the additional set of coils of the inductive angular-position sensing apparatus may be configured to accommodate any suitable combination of M and N, where M and N are positive integers, and M ≠ N. In one or more specific examples, one of the pole pairs is an even positive integer number and the other one of the pole pairs is an odd positive integer number. Thus, examples of the disclosure are not limited to sensing apparatuses having certain numbered combinations of pole pairs. In one or more examples, an inductive angular-position sensing apparatus having differently numbered combinations of pole pairs may be employed. In one or more examples, an inductive angular-position sensing apparatus may include various numbered combinations of a one pole pair sensor, a two pole pair sensor, a three pole pair sensor, a five pole pair sensor, a six pole pair sensor, a ten pole pair sensor, a twenty pole pair sensor, and so on, without limitation.

In some examples, various applications of the sensing apparatus may be provided for motor control (e.g., for rotor position sensing of motors, where the sensors are mounted inside of an assembly). For example, various examples may be provided for through-shaft sensing, with low form-factor PCBs. However, the various examples of the disclosure are not limited to these applications.

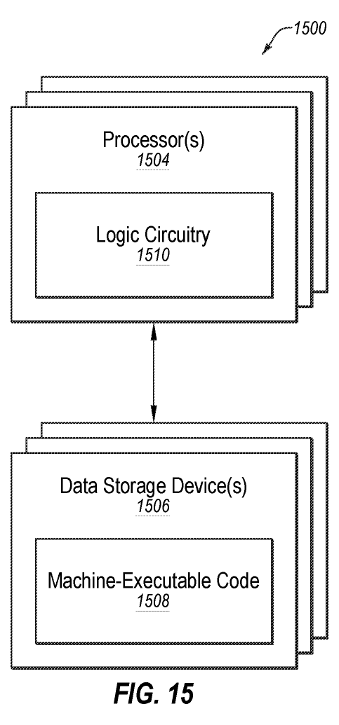

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 15 illustrates non-limiting examples of implementations of functional elements disclosed herein. In some examples, some or all portions of the functional elements disclosed herein may be performed by hardware specially implemented for carrying out the functional elements.

FIG. 15 is a block diagram of circuitry 1500 that, in some examples, may be used to implement various functions, operations, acts, processes, and/or methods disclosed herein. Circuitry 1500 includes one or more processors 1504 (sometimes referred to herein as “processors 1504”) operably coupled to one or more data storage devices (sometimes referred to herein as “storage 1506”). Storage 1506 includes machine-executable code 1508 stored thereon and processors 1504 include a logic circuitry 1510. Machine-executable code 1508 includes information describing functional elements that may be implemented by (e.g., performed by) logic circuitry 1510. Logic circuitry 1510 is adapted to implement (e.g., perform) the functional elements described by machine-executable code 1508. Circuitry 1500, when executing the functional elements described by machine-executable code 1508, should be considered as special purpose hardware for carrying out functional elements disclosed herein. In some examples, processors 1504 may perform the functional elements described by machine-executable code 1508 sequentially, concurrently (e.g., on one or more different hardware platforms), or in one or more parallel process streams.

When implemented by logic circuitry 1510 of processors 1504, machine-executable code 1508 adapts processors 1504 to perform operations of examples disclosed herein. For example, machine-executable code 1508 may be to adapt the processors 1504 to perform at least a portion or a totality of operations associated with the apparatus for inductive angular position sensing according to one or more examples, including a method of generating an output signal indicative of an angular position of a target, and a method of generating a first output signal (e.g., the first sense signal demodulated) based on a first sense signal and a second output signal (e.g., the second sense signal demodulated) based on a second sense signal.

Processors 1504 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to machine-executable code 1508 (e.g., software code, firmware code, hardware descriptions) related to examples of the present disclosure. It is noted that a general-purpose processor (may also be referred to herein as a host processor or simply a host) may be a microprocessor, but in the alternative, processors 1504 may include any conventional processor, controller, microcontroller, or state machine. Processors 1504 may also be implemented as a combination of computing devices, such as a combination of a DSP and a microprocessor, a plurality of microprocessors, one or more microprocessors in conjunction with a DSP core, or any other such configuration.

In some examples, storage 1506 includes volatile data storage (e.g., random-access memory (RAM)), non-volatile data storage (e.g., Flash memory, a hard disc drive, a solid state drive, erasable programmable read-only memory (EPROM), etc.). In some examples, processors 1504 and storage 1506 may be implemented into a single device (e.g., a semiconductor device product, a system on chip (SOC), etc.). In some examples, processors 1504 and storage 1506 may be implemented into separate devices.

In some examples, machine-executable code 1508 may include computer-readable instructions (e.g., software code, firmware code). By way of non-limiting example, the computer-readable instructions may be stored by storage 1506, accessed directly by the processors 1504, and executed by processors 1504 using at least logic circuitry 1510. Also by way of non-limiting example, the computer-readable instructions may be stored on storage 1506, transferred to a memory device (not shown) for execution, and executed by processors 1504 using at least logic circuitry 1510. Accordingly, in some examples, logic circuitry 1510 includes an electrically configurable logic circuitry.

In some examples, machine-executable code 1508 may describe hardware (e.g., circuitry) to be implemented in logic circuitry 1510 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, SystemVerilog, or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuitries (e.g., gates, flip-flops, registers, without limitation) of logic circuitry 1510 may be described in an RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, machine-executable code 1508 may include an HDL, an RTL, a GL description, a mask level description, other hardware description, or any combination thereof.

In examples where machine-executable code 1508 includes a hardware description (at any level of abstraction), a system (not shown, but including storage 1506) may be to implement the hardware description described by machine-executable code 1508. By way of non-limiting example, processors 1504 may include a programmable logic device (e.g., an FPGA or a PLC) and logic circuitry 1510 may be electrically controlled to implement circuitry corresponding to the hardware description into logic circuitry 1510. Also by way of non-limiting example, logic circuitry 1510 may include hard-wired logic manufactured by a manufacturing system (not shown, but including storage 1506) according to the hardware description of machine-executable code 1508.

Regardless of whether machine-executable code 1508 includes computer-readable instructions or a hardware description, logic circuitry 1510 is adapted to perform the functional elements described by machine-executable code 1508 when implementing the functional elements of machine-executable code 1508. It is noted that although a hardware description may not directly describe functional elements, a hardware description indirectly describes functional elements that the hardware elements described by the hardware description are capable of performing.

As used in the present disclosure, references to things (including excitation coils, sense coils, and paths, without limitation) being “at,” “in,” “on,” “arranged at,” “arranged in,” “arranged on” and like terms a support structure may refer to the things being arranged substantially within and/or on a surface of the support structure.

In addition, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

Further, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

A non-exhaustive, non-limiting list of examples follows. Note that each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.

Example 1: An apparatus comprising: a support structure; and planar coils comprising conductive traces on, or in, multiple layers of the support structure, the planar coils including a cascaded sense coil arrangement defining a continuous path between a first node and a second node, the cascaded sense coil arrangement comprising: a sense coil including a forward coil path defining M in-phase lobes circumferentially arranged about an axis, the sense coil including a return coil path defining M out-of-phase lobes circumferentially arranged about the axis; and an additional sense coil including a forward coil path defining one or more N in-phase lobes circumferentially arranged about the axis, the additional sense coil including a return coil path defining one or more N out-of-phase lobes circumferentially arranged about the axis, the additional sense coil connected in series between first and second coil segments of the sense coil, where M > N ≥ 1.

Example 2: The apparatus according to Example 1, wherein the sense coil has first and second ends respectively connected to the first and the second nodes, and wherein: a first end of the additional sense coil is connected to a first connecting end of the first coil segment of the sense coil; and a second end of the additional sense coil is connected to a second connecting end of the second coil segment of the sense coil.

Example 3: The apparatus according to Examples 1 and 2, wherein the cascaded sense coil arrangement includes: a coil meeting region at which a peak or valley portion of a lobe of the sense coil meets with a respective peak or valley portion of a lobe of the additional sense coil; and inter-coil connections located in the coil meeting region, the inter-coil connections including: a first inter-coil connection to connect the first end of the additional sense coil and the first connecting end of the first coil segment of the sense coil; and a second inter-coil connection to connect the second end of the additional sense coil and the second connecting end of the second coil segment of the sense coil.

Example 4: The apparatus according to any one of Examples 1 to 3, wherein the sense coil is to receive sense signals associated with an angular position of a first rotatable target when the first rotatable target is set about the axis, and the additional sense coil is to receive additional sense signals associated with an angular position of a second rotatable target when the second rotatable target is set about the axis.

Example 5: The apparatus according to any one of Examples 1 to 4, wherein: the sense coil defines M pole pairs for inductive angular position sensing of an angular position of a first rotatable target having M fins over a measurement range of 360/M degrees, and the additional sense coil defines one or more N pole pairs for inductive angular position sensing of an angular position of a second rotatable target having one or more N fins over an additional measurement range of 360/N degrees.

Example 6: The apparatus according to any one of Examples 1 to 5, wherein: M is a positive even integer, and N is a positive odd integer.

Example 7: The apparatus according to any one of Examples 1 to 6, wherein: M is greater than or equal to four (4), and N is equal to one (b).

Example 8: The apparatus according to any one of Examples 1 to 7, comprising: one or more oscillator coils of the planar coils; and a position sensing circuitry to: generate an excitation signal in the one or more oscillator coils to produce a varying magnetic field to induce a sense signal in the cascaded sense coil arrangement, the varying magnetic field disturbed in accordance with an angular position of a rotatable target which modulates the sense signal; receive the modulated sense signal from the cascaded sense coil arrangement; and demodulate the modulated sense signal to produce a demodulated position signal, wherein the demodulated position signal exhibits one cycle for every 360/M degrees of rotation of the rotatable target when the rotatable target comprises a first rotatable target having M fins equally circumferentially spaced about the axis, and wherein the demodulated position signal exhibits one cycle for every 360/N degrees of rotation of the rotatable target when the rotatable target comprises a second rotatable target having one or more N fins equally circumferentially spaced about the axis.

Example 9: The apparatus according to any one of Examples 1 to 8, wherein: respective ones of the M in-phase lobes of the forward coil path of the sense coil circumferentially arranged to be 180/M degrees out of phase with respective adjacent ones of the M out-of-phase lobes of the return coil path of the sense coil, and respective ones of the one or more N in-phase lobes of the forward coil path of the additional sense coil circumferentially arranged to be 180/N degrees out of phase with respective adjacent ones of the one or more N out-of-phase lobes of the return coil path of the additional sense coil.

Example 10: The apparatus according to any one of Examples 1 to 9, wherein the cascaded sense coil arrangement includes: a first inter-lobe region in which first and second crossover connections of the sense coil are located, the first inter-lobe region comprising a region in which the in-phase lobe of the forward coil path of the sense coil meets with the out-of-phase lobe of the return coil path of the sense coil; and a second inter-lobe region in which third and fourth crossover connections of the sense coil are located, the second inter-lobe region comprising a region in which the in-phase lobe of the forward coil path of the additional sense coil meets with the out-of-phase lobe of the return coil path of the additional sense coil.

Example 11: The apparatus according to any one of Examples 1 to 10, wherein: the first crossover connection connects an ending portion of an in-phase lobe of the forward coil path of the sense coil to a starting portion of an out-of-phase lobe of the return coil path of the sense coil; the second crossover connection connects an ending portion of the out-of-phase lobe of the return coil path to a starting portion of the in-phase lobe of the forward coil path of the sense coil; the third crossover connection connects an ending portion of an in-phase lobe of the forward coil path of the additional sense coil to a starting portion of an out-of-phase lobe of the return coil path of the additional sense coil; and the fourth crossover connection connects an ending portion of the out-of-phase lobe of the return coil path of the additional sense coil to a starting portion of the in-phase lobe of the forward coil path of the additional sense coil.

Example 12: The apparatus according to any one of Examples 1 to 11, wherein the cascaded sense coil arrangement comprises a first cascaded sense coil arrangement, the continuous path comprises a first continuous path, the sense coil comprises a first sense coil, the additional sense coil comprises an additional first sense coil, the planar coils comprising: a second cascaded sense coil arrangement defining a second continuous path between a third node and a fourth node, the second cascaded sense coil arrangement comprising: a second sense coil including a forward coil path defining M in-phase lobes circumferentially arranged about the axis, the second sense coil including a return coil path defining M out-of-phase lobes circumferentially arranged about the axis, the second sense coil having first and second ends respectively connected to the third and the fourth nodes; and an additional second sense coil including a forward coil path defining one or more N in-phase lobes circumferentially arranged about the axis, the additional second sense coil including a return coil path defining one or more N out-of-phase lobes circumferentially arranged about the axis, the additional second sense coil connected in series between first and second coil segments of the second sense coil; respective ones of the M in-phase lobes of the forward coil path of the second sense coil circumferentially arranged to be 180/M degrees out-of-phase with respective adjacent ones of the M out-of-phase lobes of the return coil path of the second sense coil; and respective ones of the one or more N in-phase lobes of the forward coil path of the additional second sense coil circumferentially arranged to be 180/N degrees out of phase with respective adjacent ones of the one or more N out-of-phase lobes of the return coil path of the additional second sense coil.

Example 13: The apparatus according to any one of Examples 1 to 12, wherein: respective ones of 2*M lobes of the first sense coil circumferentially arranged to be 90/M degrees out of phase with respective adjacent ones of 2*M lobes of the second sense coil; and respective ones of 2*N lobes of the additional first sense coil circumferentially arranged to be 90/N degrees out of phase with respective adjacent ones of 2*N lobes of the additional second sense coil.

Example 14: The apparatus according to any one of Examples 1 to 13, wherein the second cascaded sense coil arrangement includes: a second coil meeting region in which a peak or valley portion of a lobe of the second sense coil meets with a respective peak or valley portion of a lobe of the additional second sense coil.

Example 15: The apparatus according to any one of Examples 1 to 14, wherein the additional second sense coil includes: a first end connected to a first connecting end of the first coil segment of the second sense coil; and a second end connected to a second connecting end of the second coil segment of the second sense coil.

Example 16: The apparatus according to any one of Examples 1 to 15, wherein the additional second sense coil includes: inter-coil connections in the second coil meeting region, the inter-coil connections including: a third inter-coil connection to connect the first end of the additional second sense coil and the first connecting end of the first coil segment of the second sense coil; and a fourth inter-coil connection to connect the second end of the additional second sense coil and the second connecting end of the second coil segment of the second sense coil.

Example 17: The apparatus according to any one of Examples 1 to 16, wherein: respective ones of the first and the second sense coils define M pole pairs for inductive angular position sensing over a measurement range; and respective ones of the additional first and the second sense coils define one or more N pole pairs for inductive angular position sensing over an additional measurement range.

Example 18: An apparatus comprising: a support structure; and planar coils comprising conductive traces on, or in, multiple layers of the support structure, the planar coils including a cascaded sense coil arrangement defining a continuous path between a first node and a second node, the cascaded sense coil arrangement comprising: a sense coil including a forward coil path defining M in-phase lobes circumferentially arranged about an axis, the sense coil including a return coil path defining M out-of-phase lobes circumferentially arranged about the axis, where M is a positive even integer greater than or equal to four (4), the sense coil having first and second ends respectively connected to the first and the second nodes; an additional sense coil including a forward coil path defining one (1) in-phase lobe about the axis, the additional sense coil including a return coil path defining one (1) out-of-phase lobe about the axis; and inter-coil connections in a coil meeting region of the sense coil and the additional sense coil, the inter-coil connections to connect the additional sense coil in series between first and second coil segments of the sense coil.

Example 19: The apparatus according to Example 18, wherein the coil meeting region comprises a region in which a peak or valley portion of a lobe of the sense coil meets with a respective peak or valley portion of a lobe of the additional sense coil, the inter-coil connections including: a first inter-coil connection to connect a first end of the additional sense coil and a first connecting end of the first coil segment of the sense coil; and a second inter-coil connection to connect a second end of the additional sense coil and a second connecting end of the second coil segment of the sense coil.

Example 20: The apparatus according to Examples 18 and 19, wherein: the sense coil defines M pole pairs for inductive angular position sensing over a measurement range of 360/M degrees for a first target having M fins; and the additional sense coil defines one (1) pole pair for inductive angular position sensing over an additional measurement range of 360 degrees for a second target having one (1) fin.

Example 21: The apparatus according to any one of Examples 18 to 20, comprising: one or more oscillator coils of the set of planar coils; and a position sensing circuitry to: generate an excitation signal in the one or more oscillator coils to produce a varying magnetic field to induce a sense signal in the cascaded sense coil arrangement, the varying magnetic field disturbed in accordance with an angular position of a rotatable target which modulates the sense signal; receive the modulated sense signal from the cascaded sense coil arrangement; and demodulate the modulated sense signal to produce a demodulated position signal, wherein the demodulated position signal exhibits one cycle for every 360/M degrees of rotation of the rotatable target comprising a first rotatable target having M fins, and wherein the demodulated position signal exhibits one cycle for every 360/N degrees of rotation of the rotatable target comprising a second rotatable target having one or more N fins.

Example 22: An apparatus comprising: an inductive angular position sensor to sense inductive angular position signals associated with an angular position of a first rotatable target when the first rotatable target is set about an axis, the inductive angular position sensor to sense inductive angular position signals associated with an angular position of a second rotatable target when the second rotatable target is set about the axis, the inductive angular position sensor including: a support structure; and planar coils comprising conductive traces on, or in, multiple layers of the support structure, the planar coils including: one or more oscillator coils; a first cascaded sense coil arrangement defining a first continuous path between a first node and a second node, the first cascaded sense coil arrangement including a first sense coil defining M pole pairs and an additional first sense coil defining one or more N pole pairs, the additional first sense coil connected in series with first and second coil segments of the first sense coil; and a second cascaded sense coil arrangement defining a second continuous path between a third node and a fourth node, the second cascaded sense coil arrangement including a second sense coil defining the M pole pairs and an additional second sense coil defining the one or more N pole pairs, the additional second sense coil connected in series with first and second coil segments of the second sense coil, where M > N ≥ 1.

Example 23: The apparatus according to Example 22, wherein: the first sense coil has first and second ends respectively connected to the first and the second nodes, and the second sense coil has first and second ends respectively connected to the third and the fourth nodes.

Example 23: The apparatus according to Example 22, wherein the planar coils include: a first pair of inter-coil connections in a first coil meeting region of the first sense coil and the additional first sense coil, the first pair of inter-coil connections to connect the additional first sense coil in series between the first and the second coils segments of the first sense coil; and a second pair of inter-coil connections in a second coil meeting region of the second sense coil and the additional second sense coil, the second pair of inter-coil connections to connect the additional second sense coil in series between the first and the second coils segments of the second sense coil.

Example 24: The apparatus according to Examples 22 and 23, wherein the inductive angular position sensor comprises: a position sensing circuitry to: generate an excitation signal in the one or more oscillator coils to produce a varying magnetic field to induce first and second sense signals in the first and the second cascaded sense coil arrangements, respectively, the varying magnetic field disturbed in accordance with the angular position of a rotatable target which modulates the first and the second sense signals; receive the modulated first and second sense signals from the first and the second cascaded sense coil arrangements, respectively; and demodulate the modulated first and second sense signals to produce demodulated first and second position signals, respectively, wherein respective ones of the demodulated first and the second position signals exhibit one cycle for every 360/M degrees of rotation of the rotatable target comprising the first rotatable target having M fins, and wherein respective ones of the demodulated first and the second position signals exhibit one cycle for every 360/N degrees of rotation of the rotatable target comprising the second rotatable target having one or more N fins.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus comprising:
a support structure; and
planar coils comprising conductive traces on, or in, multiple layers of the support structure, the planar coils including a cascaded sense coil arrangement defining a continuous path between a first node and a second node, the cascaded sense coil arrangement comprising:
a sense coil including a forward coil path defining M in-phase lobes circumferentially arranged about an axis, the sense coil including a return coil path defining M out-of-phase lobes circumferentially arranged about the axis; and
an additional sense coil including a forward coil path defining one or more N in-phase lobes circumferentially arranged about the axis, the additional sense coil including a return coil path defining one or more N out-of-phase lobes circumferentially arranged about the axis, the additional sense coil connected in series between first and second coil segments of the sense coil, where M > N ≥ 1.

2. The apparatus of claim 1, wherein the sense coil has first and second ends respectively connected to the first and the second nodes, and wherein:
a first end of the additional sense coil is connected to a first connecting end of the first coil segment of the sense coil, and
a second end of the additional sense coil is connected to a second connecting end of the second coil segment of the sense coil.

3. The apparatus of claim 2, wherein the cascaded sense coil arrangement includes:
a coil meeting region at which a peak or valley portion of a lobe of the sense coil meets with a respective peak or valley portion of a lobe of the additional sense coil; and
inter-coil connections located in the coil meeting region, the inter-coil connections including:
a first inter-coil connection to connect the first end of the additional sense coil and the first connecting end of the first coil segment of the sense coil; and
a second inter-coil connection to connect the second end of the additional sense coil and the second connecting end of the second coil segment of the sense coil.

4. The apparatus of claim 1, wherein:
the sense coil is to receive sense signals associated with an angular position of a first rotatable target when the first rotatable target is set about the axis, and
the additional sense coil is to receive additional sense signals associated with an angular position of a second rotatable target when the second rotatable target is set about the axis.

5. The apparatus of claim 1, wherein:
the sense coil defines M pole pairs for inductive angular position sensing of an angular position of a first rotatable target having M fins over an angular position measurement range of 360/M degrees, and
the additional sense coil defines one or more N pole pairs for inductive angular position sensing of an angular position of a second rotatable target having one or more N fins over an additional angular position measurement range of 360/N degrees.

6. The apparatus of claim 1, wherein:
M is a positive even integer, and
N is a positive odd integer.

7. The apparatus of claim 6, wherein:
M is greater than or equal to four (4), and
N is equal to one (1).

8. The apparatus of claim 1, comprising:
one or more oscillator coils of the planar coils; and
a position sensing circuitry to:
generate an excitation signal in the one or more oscillator coils to produce a varying magnetic field to induce a sense signal in the cascaded sense coil arrangement, the varying magnetic field disturbed in accordance with an angular position of a rotatable target which modulates the sense signal;
receive the modulated sense signal from the cascaded sense coil arrangement; and
demodulate the modulated sense signal to produce a demodulated position signal,
wherein the demodulated position signal exhibits one cycle for every 360/M degrees of rotation of the rotatable target when the rotatable target comprises a first rotatable target having M fins equally circumferentially spaced about the axis, and
wherein the demodulated position signal exhibits one cycle for every 360/N degrees of rotation of the rotatable target when the rotatable target comprises a second rotatable target having one or more N fins equally circumferentially spaced about the axis.

9. The apparatus of claim 1, wherein:
respective ones of the M in-phase lobes of the forward coil path of the sense coil circumferentially arranged to be 180/M degrees out of phase with respective adjacent ones of the M out-of-phase lobes of the return coil path of the sense coil, and
respective ones of the one or more N in-phase lobes of the forward coil path of the additional sense coil circumferentially arranged to be 180/N degrees out of phase with respective adjacent ones of the one or more N out-of-phase lobes of the return coil path of the additional sense coil.

10. The apparatus of claim 1, wherein the cascaded sense coil arrangement includes:
a first inter-lobe region in which first and second crossover connections of the sense coil are located, the first inter-lobe region comprising a region in which the in-phase lobe of the forward coil path of the sense coil meets with the out-of-phase lobe of the return coil path of the sense coil; and
a second inter-lobe region in which third and fourth crossover connections of the sense coil are located, the second inter-lobe region comprising a region in which the in-phase lobe of the forward coil path of the additional sense coil meets with the out-of-phase lobe of the return coil path of the additional sense coil.

11. The apparatus of claim 10, wherein:
the first crossover connection connects an ending portion of an in-phase lobe of the forward coil path of the sense coil to a starting portion of an out-of-phase lobe of the return coil path of the sense coil;
the second crossover connection connects an ending portion of the out-of-phase lobe of the return coil path to a starting portion of the in-phase lobe of the forward coil path of the sense coil;
the third crossover connection connects an ending portion of an in-phase lobe of the forward coil path of the additional sense coil to a starting portion of an out-of-phase lobe of the return coil path of the additional sense coil; and
the fourth crossover connection connects an ending portion of the out-of-phase lobe of the return coil path of the additional sense coil to a starting portion of the in-phase lobe of the forward coil path of the additional sense coil.

12. The apparatus of claim 1, wherein the cascaded sense coil arrangement comprises a first cascaded sense coil arrangement, the continuous path comprises a first continuous path, the sense coil comprises a first sense coil, and the additional sense coil comprises an additional first sense coil, the planar coils comprising:
a second cascaded sense coil arrangement defining a second continuous path between a third node and a fourth node, the second cascaded sense coil arrangement comprising:
a second sense coil including a forward coil path defining M in-phase lobes circumferentially arranged about the axis, the second sense coil including a return coil path defining M out-of-phase lobes circumferentially arranged about the axis, the second sense coil having first and second ends respectively connected to the third and the fourth nodes; and
an additional second sense coil including a forward coil path defining one or more N in-phase lobes circumferentially arranged about the axis, the additional second sense coil including a return coil path defining one or more N out-of-phase lobes circumferentially arranged about the axis, the additional second sense coil connected in series between first and second coil segments of the second sense coil;
respective ones of the M in-phase lobes of the forward coil path of the second sense coil circumferentially arranged to be 180/M degrees out of phase with respective adjacent ones of the M out-of-phase lobes of the return coil path of the second sense coil; and
respective ones of the one or more N in-phase lobes of the forward coil path of the additional second sense coil circumferentially arranged to be 180/N degrees out of phase with respective adjacent ones of the one or more N out-of-phase lobes of the return coil path of the additional second sense coil.

13. The apparatus of claim 12, wherein:
respective ones of 2*M lobes of the first sense coil circumferentially arranged to be 90/M degrees out of phase with respective adjacent ones of 2*M lobes of the second sense coil; and
respective ones of 2*N lobes of the additional first sense coil circumferentially arranged to be 90/N degrees out of phase with respective adjacent ones of 2*N lobes of the additional second sense coil.

14. The apparatus of claim 13, wherein the second sense coil arrangement includes:
a second coil meeting region in which a peak or valley portion of a lobe of the second sense coil meets with a respective peak or valley portion of a lobe of the additional second sense coil.

15. The apparatus of claim 14, wherein:
a first end of the additional second sense coil is connected to a first connecting end of the first coil segment of the second sense coil; and
a second end of the additional second sense coil is connected to a second connecting end of the second coil segment of the second sense coil.

16. The apparatus of claim 15, wherein the additional second sense coil includes:
inter-coil connections in the second coil meeting region, the inter-coil connections including:
a third inter-coil connection to connect the first end of the additional second sense coil and the first connecting end of the first coil segment of the second sense coil; and
a fourth inter-coil connection to connect the second end of the additional second sense coil and the second connecting end of the second coil segment of the second sense coil.

17. The apparatus of claim 12, wherein:
respective ones of the first sense coil and the second sense coil define M pole pairs for inductive angular position sensing over an angular position measurement range; and
respective ones of the additional first sense coil and the additional second sense coil define one or more N pole pairs for inductive angular position sensing over an additional angular position measurement range.

18. An apparatus comprising:
a support structure; and
planar coils comprising conductive traces on, or in, multiple layers of the support structure, the planar coils including a cascaded sense coil arrangement defining a continuous path between a first node and a second node, the cascaded sense coil arrangement comprising:
a sense coil including a forward coil path defining M in-phase lobes circumferentially arranged about an axis, the sense coil including a return coil path defining M out-of-phase lobes circumferentially arranged about the axis, where M is a positive even integer greater than or equal to four (4), the sense coil having first and second ends respectively connected to the first and the second nodes;
an additional sense coil including a forward coil path defining one (1) in-phase lobe about the axis, the additional sense coil including a return coil path defining one (1) out-of-phase lobe about the axis; and
inter-coil connections in a coil meeting region of the sense coil and the additional sense coil, the inter-coil connections to connect the additional sense coil in series between first and second coil segments of the sense coil.

19. The apparatus of claim 18, wherein the coil meeting region comprises a region in which a peak or valley portion of a lobe of the sense coil meets with a respective peak or valley portion of a lobe of the additional sense coil, the inter-coil connections including:
a first inter-coil connection to connect a first end of the additional sense coil and a first connecting end of the first coil segment of the sense coil; and
a second inter-coil connection to connect a second end of the additional sense coil and a second connecting end of the second coil segment of the sense coil.

20. The apparatus of claim 18, wherein:
the sense coil defines M pole pairs for inductive angular position sensing over an angular position measurement range of 360/M degrees for a first rotatable target having M fins; and
the additional sense coil defines one (1) pole pair for inductive angular position sensing over an additional angular position measurement range of 360 degrees for a second rotatable target having one (1) fin.

21. The apparatus of claim 18, comprising:
one or more oscillator coils of the planar coils; and
a position sensing circuitry to:
generate an excitation signal in the one or more oscillator coils to produce a varying magnetic field to induce a sense signal in the sense coil arrangement, the varying magnetic field disturbed in accordance with an angular position of a rotatable target which modulates the sense signal;
receive the modulated sense signal from the sense coil arrangement; and
demodulate the modulated sense signal to produce a demodulated position signal,
wherein the demodulated position signal exhibits one cycle for every 360/M degrees of rotation of the rotatable target comprising a first rotatable target having M fins, and
wherein the demodulated position signal exhibits one cycle for every 360/N degrees of rotation of the rotatable target comprising a second rotatable target having one or more N fins.

22. An apparatus comprising:
an inductive angular position sensor to sense first and second sense signals associated with an angular position of a first rotatable target when the first rotatable target is set about an axis, the inductive angular position sensor to sense additional first and second sense signals associated with an angular position of a second rotatable target when the second rotatable target is set about the axis, the inductive angular position sensor including:
a support structure; and
planar coils comprising conductive traces on, or in, multiple layers of the support structure, the planar coils including:
one or more oscillator coils;
a first cascaded sense coil arrangement defining a first continuous path between a first node and a second node, the first cascaded sense coil arrangement including a first sense coil defining M pole pairs about the axis and an additional first sense coil defining one or more N pole pairs about the axis, the additional first sense coil connected in series between first and second coil segments of the first sense coil; and
a second cascaded sense coil arrangement defining a second continuous path between a third node and a fourth node, the second cascaded sense coil arrangement including a second sense coil defining the M pole pairs about the axis and an additional second sense coil defining the one or more N pole pairs about the axis, the additional second sense coil connected in series between first and second coil segments of the second sense coil, where M > N ≥ 1.

23. The apparatus of claim 22, wherein:
the first sense coil has first and second ends respectively connected to the first and the second nodes, and
the second sense coil has first and second ends respectively connected to the third and the fourth nodes.

24. The apparatus of claim 23, wherein the planar coils including:
a first pair of inter-coil connections in a first coil meeting region of the first sense coil and the additional first sense coil, the first pair of inter-coil connections to connect the additional first sense coil in series between the first and the second coil segments of the first sense coil; and
a second pair of inter-coil connections in a second coil meeting region of the second sense coil and the additional second sense coil, the second pair of inter-coil connections to connect the additional second sense coil in series between the first and the second coil segments of the second sense coil.

25. The apparatus of claim 22, wherein the inductive angular position sensor comprises:
a position sensing circuitry to:
generate an excitation signal in the one or more oscillator coils to produce a varying magnetic field to induce first and second sense signals in the first and the second cascaded sense coil arrangements, respectively, the varying magnetic field disturbed in accordance with the angular position of a rotatable target which modulates the first and the second sense signals;
receive the modulated first and second sense signals from the first and the second cascaded sense coil arrangements, respectively; and
demodulate the modulated first and second sense signals to produce demodulated first and second position signals, respectively,
wherein respective ones of the demodulated first and the second position signals exhibit one cycle for every 360/M degrees of rotation of the rotatable target comprising the first rotatable target having M fins, and
wherein respective ones of the demodulated first and the second position signals exhibit one cycle for every 360/N degrees of rotation of the rotatable target comprising the second rotatable target having one or more N fins.
